(19) United States
(12) Patent Application Publication
(10) Pub. No.: US 2026/0346843 A1
(43) Pub. Date: Nov. 5, 2026

(54) EFFICIENCY BRAKE SYSTEM

(71) Applicant: SoftBank Group Corp., Minato-Ku, Tokyo (JP)

(72) Inventor: Masayoshi SON, Tokyo (JP)

(21) Appl. No.: 19/120,685

(22) PCT Filed: Oct. 17, 2023
(86) PCT No.: PCT/JP2023/037542

§ 371 Date: Apr. 11, 2025

(30) Foreign Application Priority Data
Oct. 31, 2022 (JP) 2022-174994
Nov. 14, 2022 (JP) 2022-181942
Nov. 21, 2022 (JP) 2022-185687
Dec. 14, 2022 (JP) 2022-199548
Feb. 9, 2023 (JP) 2023-018712

(51) Int. Cl. B60W 30/18; B60W 10/184; B60W 10/20; B60W 50/14

(52) U.S. Cl. CPC B60W 30/18109; B60W 10/184; B60W 10/20; B60W 2050/143; B60W 2520/105; B60W 2520/28; B60W 2554/802; B60W 2554/804; B60W 2710/18; B60W 2710/207

(57) ABSTRACT

An efficiency brake system includes at least a pair of wheels positioned substantially symmetrically on the left and right of a vehicle, steering means capable of individually controlling a steering angle of each of the pair of wheels, and a control unit that acquires or generates information regarding deceleration of the vehicle and controls the steering means so that a right-side wheel of the pair of wheels faces leftward and a left-side wheel faces rightward or the right-side wheel faces rightward and the left-side wheel faces leftward, with respect to a traveling direction of the vehicle, when the information is acquired or generated.

### CROSS-REFERENCE TO RELATED APPLICATIONS

The present application is based on Japanese Patent Application No. 2022-174994 filed on Oct. 31, 2022, Japanese Patent Application No. 2022-181942 filed on Nov. 14, 2022, Japanese Patent Application No. 2022-185687 filed on Nov. 21, 2022, Japanese Patent Application No. 2022-199548 filed on Dec. 14, 2022, and Japanese Patent Application No. 2023-018712 filed on Feb. 9, 2023, the contents of which are incorporated herein by reference.

### TECHNICAL FIELD

The present invention relates to an efficiency brake system.

### BACKGROUND ART

Conventionally, in a two-wheel drive vehicle or a four-wheel drive vehicle, rotation of tires of drive wheels is decelerated to stop or decelerate the vehicle. For example, Patent Literature 1 describes a brake device that changes a brake force by controlling a strength of a regenerative brake force.

### CITATION LIST

### Patent Literature

Patent Literature 1: JP 2020-145874 A

### SUMMARY OF INVENTION

In a two-wheel drive vehicle, rear wheels of a front wheel drive vehicle and front wheels of a rear wheel drive vehicle only simply follow drive wheels and are not braking targets. Therefore, even if a rotation speed of a tire drops, a force for traveling in a traveling direction acts on the tire, and deceleration power is weak.

Therefore, an object of the present invention is to provide a brake that can perform deceleration of a vehicle faster and at a shorter distance.

An efficiency brake system according to one aspect of the present invention includes at least a pair of wheels positioned substantially symmetrically on the left and right of a vehicle, steering means capable of individually controlling a steering angle of each of the pair of wheels, and a control unit that acquires or generates information regarding deceleration of the vehicle and controls the steering means so that a right-side wheel of the pair of wheels faces leftward and a left-side wheel faces rightward or the right-side wheel faces rightward and the left-side wheel faces leftward, with respect to a traveling direction of the vehicle, when the information is acquired or generated.

According to one aspect of the present invention, it is possible to decelerate a vehicle faster and at a shorter distance.

### BRIEF DESCRIPTION OF DRAWINGS

FIG. 1 is a diagram showing an example of a system configuration of a vehicle 1 on which an efficiency brake system according to a first embodiment is mounted.

FIG. 2 is a diagram showing an example of a configuration of a control unit 10 according to the present embodiment.

FIG. 3 is a diagram showing an example of the efficiency brake system according to the present embodiment.

FIG. 4 is a diagram showing an example of the efficiency brake system according to the present embodiment.

FIG. 5 is a flowchart showing an example of a processing procedure of a vehicle 1 on which the efficiency brake system is mounted.

FIG. 6 is a diagram in which an efficiency brake according to the present embodiment and a conventional brake are compared with each other.

FIG. 7 is a diagram showing an example of a system configuration of the vehicle 1 on which an efficiency brake system according to a second embodiment is mounted.

FIG. 8 is a flowchart showing an example of a processing procedure of the vehicle 1 on which the efficiency brake system according to the present embodiment is mounted.

FIG. 9 is a diagram showing acceleration data when a collision accident occurs, in the present embodiment.

FIG. 10 is a diagram showing an example of a system configuration of a vehicle on which an efficiency brake system according to a third embodiment is mounted.

FIG. 11 is a diagram showing an example of an operation mode of the efficiency brake.

FIG. 12 is a diagram showing an example of the operation mode of the efficiency brake.

FIG. 13 is a diagram showing an example of the operation mode of the efficiency brake.

FIG. 14 is a flowchart showing an example of a processing procedure of the vehicle on which the efficiency brake system is mounted.

FIG. 15 is a diagram showing an example of a system configuration of a vehicle on which a brake system according to a fourth embodiment is mounted.

FIG. 16 is an explanatory diagram showing an example of the brake type selection operation.

FIG. 17 is a flowchart showing an example of the processing procedure of the vehicle on which the brake system is mounted.

FIG. 18 is a diagram showing an example of a system configuration of a vehicle 1 on which an efficiency brake system according to a fifth embodiment is mounted.

FIG. 19 is a flowchart showing an example of a processing procedure of the vehicle 1 on which the efficiency brake system according to the present embodiment is mounted.

FIG. 20 is a diagram for explaining control of a steering angle of a wheel 30 by steering means 20 according to the present embodiment.

FIG. 21 is a diagram for explaining the control of the steering angle of the wheel 30 by the steering means 20 according to the present embodiment.

FIG. 22 is a diagram showing a relationship between a speed of the vehicle 1 and the steering angle of the wheel 30 according to the present embodiment.

FIG. 23 is a diagram for explaining control of the steering angle of the wheel 30 during curve traveling in the present embodiment.

FIG. 24 is a diagram for explaining the control of the steering angle of the wheel 30 during curve traveling in the present embodiment.

FIG. 25 is a diagram showing an example of pattern data of the steering angle of the wheel 30 according to the present embodiment.

### DESCRIPTION OF EMBODIMENTS

Embodiments of the present invention will be described with reference to the accompanying drawings. Note that, in each drawing, components denoted by the same reference numeral have the same or similar configuration.

### (1) First Embodiment

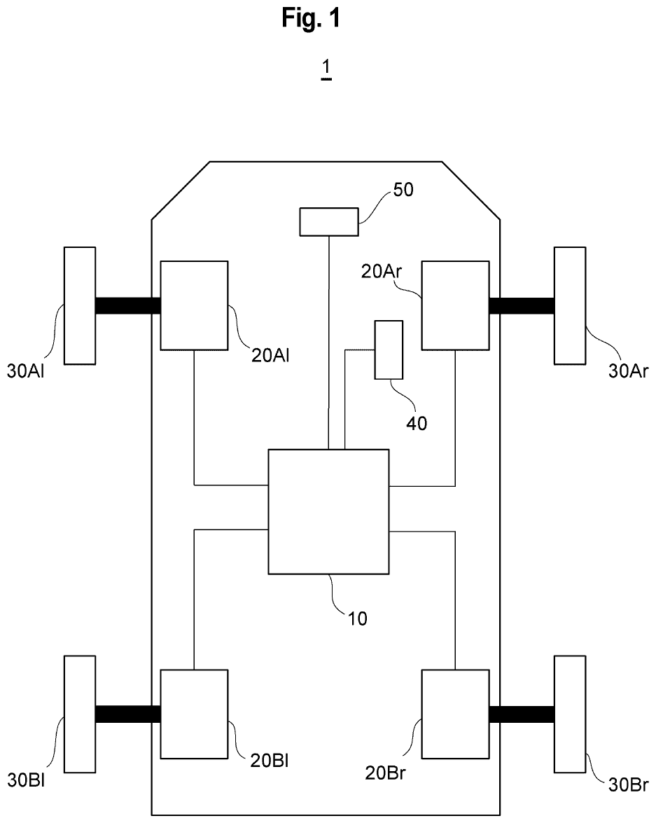

FIG. 1 is a diagram showing an example of a system configuration of a vehicle 1 on which an efficiency brake system according to the present embodiment is mounted. The vehicle 1 shown in FIG. 1 includes a control unit 10, steering means 20, wheels 30, a first sensor 40, and a second sensor 50. Furthermore, although not shown, various components constituting a conventional vehicle may be included. The vehicle 1 has an automatic driving function for assisting automatic driving of the vehicle 1, in addition to a manual driving function in which a driver drives the vehicle 1, and each mode may be arbitrarily selected.

The control unit 10 can cause the steering means 20 to control a steering angle of the wheel 30, using various types of information acquired from inside and outside of the vehicle 1. For example, the control unit 10 instructs the steering angle of the wheel 30, to the steering means 20, based on information detected by the first sensor 40 and/or the second sensor 50. At this time, the control unit 10 may acquire information regarding deceleration of the vehicle 1 from the first sensor 40. Furthermore, the control unit 10 may generate the information regarding the deceleration based on the information acquired from the first sensor 40 and/or the second sensor 50.

The steering means 20 can individually control the steering angle of each wheel 30, based on the instruction received from the control unit 10. In the present embodiment, as the steering means 20, steering means 20Ar, 20Al, 20Br, and 20Bl respectively corresponding to four wheels 30Ar, 30Al, 30Br, and 30Bl included in the vehicle 1 are included, and each of the steering means 20Ar, 20Al, 20Br, and 20Bl may be configured to individually set and control a steering angle of each of the wheels 30Ar, 30Al, 30Br, and 30Bl.

As the wheels 30, the vehicle 1 includes at least a pair of wheels, and the wheels are substantially symmetrically arranged on the left and right of the vehicle 1. In the present embodiment, the vehicle 1 includes four wheels, that is, a pair of right and left front wheels 30A (30Ar and 30Al) and a pair of right and left rear wheels 30B (30Br and 30Bl).

A hub motor (HUB motor) may be mounted on the wheel 30. The HUB motor may also be referred to as an in wheel motor (IWM). The HUB motor is mounted on all the four wheels, a movement of each of the wheels 30 can be individually controlled. Therefore, this is preferable to realize an efficiency brake that changes angles of the wheels and performs deceleration.

The first sensor 40 detects information regarding a brake. For example, the first sensor 40 detects that the driver steps on a brake pedal and transmits the detected information to the control unit 10.

The second sensor 50 may be various sensors mounted on the vehicle 1. For example, the second sensor 50 may be a speed sensor or an acceleration sensor. The second sensor 50 transmits detected information to the control unit 10.

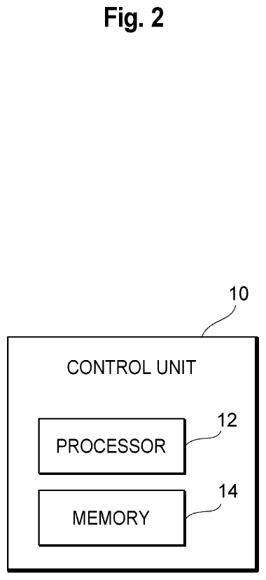

FIG. 2 is a diagram showing an example of a configuration of the control unit 10 according to the present embodiment. The control unit 10 includes, for example, a processor 12 and a memory 14.

The processor 12 controls an operation of the entire vehicle 1. As the processor 12, for example, a central processing unit (CPU), a micro processing unit (MPU), a field programmable gate array (FPGA), a microcomputer (microcontroller), or the like can be used. The processor 12 functions as a control unit that controls the operation of the entire vehicle 1, by executing a program stored in the memory 14.

The memory 14 stores various programs to be executed by the processor 12 and various types of data. The memory 14 may include, for example, a volatile storage device such as a read only memory (ROM) or a random access memory (RAM) and a nonvolatile storage device such as a hard disk drive (HDD) or a flash memory.

As various types of data, for example, pattern data of the steering angles of the four respective wheel 30Ar, 30Al, 30Br, and 30Bl, when the efficiency brake is used, is included.

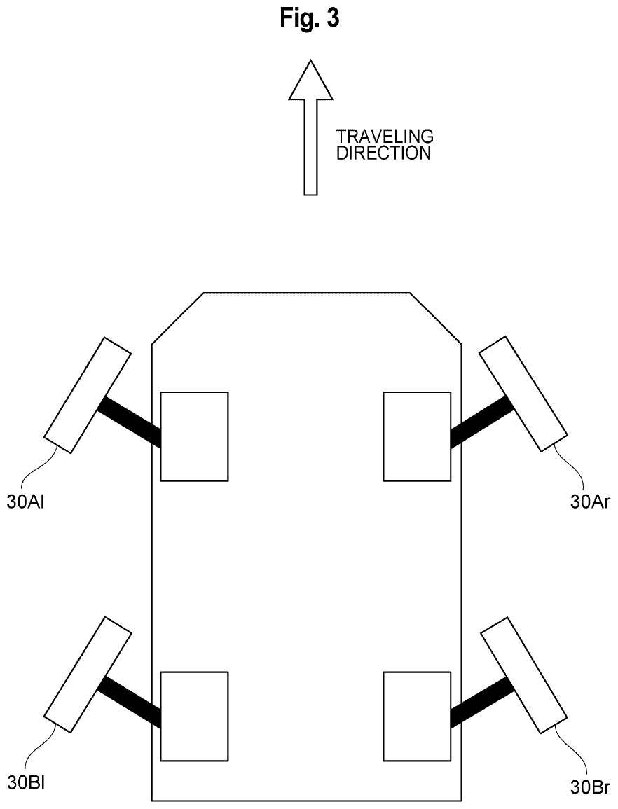

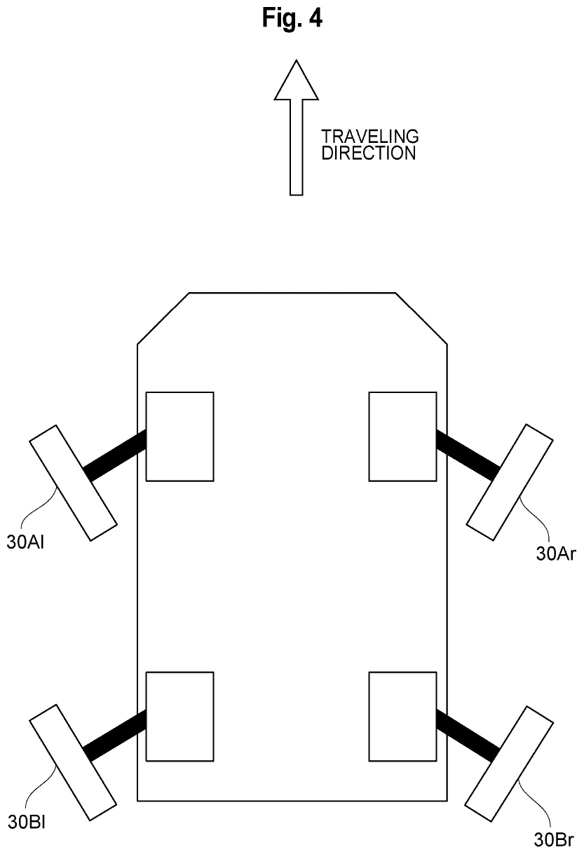

FIGS. 3 and 4 are diagrams showing an example of the efficiency brake system according to the present embodiment. The efficiency brake is a method for decelerating the vehicle 1 in which it is possible to individually steer each of at least a pair of left and right wheels, by controlling the steering angle of the pair of left and right wheels. For example, in the vehicle 1 that can be steered with all the four wheels, each of the steering angles of the four wheels may be individually controlled to perform deceleration.

When the HUB motor is mounted on the wheel 30, the steering angles of all the four wheels can be freely controlled. Although a rotation speed of the wheel is usually weakened by friction with a brake when the vehicle is decelerated, in the present embodiment, the steering angle of the wheel is controlled to cancel a moment toward the traveling direction, by using that all the four steering angles can be changed.

For example, as shown in FIG. 3, in the vehicle 1 that can be steered with all the four wheels, the control unit 10 controls the steering angles so that each of the pair of front wheels 30A and the pair of rear wheels 30B forms a shape of reverse “V”, as viewed from an upper surface of the vehicle, using the steering means 20. That is, the control unit 10 controls the steering angles so as that the right-side wheel 30Ar faces leftward and the left-side wheel 30Al faces rightward, of the pair of front wheels 30A, using the steering means 20. Furthermore, the control unit 10 controls the steering angles so that the right-side wheel 30Br faces leftward and the left-side wheel 30Bl faces rightward, of the pair of rear wheels 30B, using the steering means 20.

Furthermore, as shown in FIG. 4, in the vehicle 1 that can be steered with all the four wheels, the steering angles are controlled so that each of the pair of front wheels 30A and the pair of rear wheels 30B forms a shape of reverse “V”, as viewed from an upper surface of the vehicle, using the steering means 20 of the control unit 10, as viewed from the upper surface of the vehicle. That is, the control unit 10 controls the steering angles so that the right-side wheel 30Ar faces rightward and the left-side wheel 30Al faces leftward, of the pair of front wheels 30A, using the steering means 20. Furthermore, the control unit 10 controls the steering angles so that the right-side wheel 30Br faces rightward and the left-side wheel 30Bl faces leftward, of the pair of rear wheels 30B, using the steering means 20.

In this way, in the efficiency brake system according to the present embodiment, by narrowing a traveling direction side of the pairs of left and right wheels 30A and 30B toward the inner side or widening the traveling direction side to the outer side, a frictional force on a contact surface between the wheel 30 and the ground is increased, and the deceleration is realized. At this time, by adjusting the steering angle of the wheel 30, it is possible to adjust a friction coefficient between the wheel 30 and the ground and to adjust the frictional force.

Furthermore, the control unit 10 may set the steering angles so that the front wheels 30A form the shape of reverse “V” and the rear wheels 30B form the shape of “V”, using the steering means 20. Furthermore, the control unit 10 may set the steering angles so that the front wheels 30A form the shape of “V” and the rear wheels 30B form the shape of reverse “V”, using the steering means 20.

The control unit 10 may control the steering means 20 so that an angle between the traveling direction of the vehicle 1 and the steering angle of the right-side wheel 30Ar or 30Br, among the pair of wheels 30A and 30B and an angle between the traveling direction of the vehicle 1 and the steering angle of the left-side wheel 30Al or 30Bl are substantially identical to each other. That is, the steering means 20 may be controlled so that an angle formed by the traveling direction of the vehicle 1 and a rotation surface of the wheel 30Ar or 30Br and an angle formed by the traveling direction of the vehicle 1 and a rotation surface of the wheel 30Al or 30Bl are substantially identical to each other. As a result, the frictional forces acting on the left and right wheels are substantially identical to each other, and it can be expected that steering at the time of deceleration is stabilized.

Furthermore, the control unit 10 may set the steering angle of each wheel 30, according to a speed and/or an acceleration of the vehicle 1. For example, the control unit 10 acquires the speed and/or the acceleration based on the information detected by the second sensor 50. Then, the steering angle suitable for the speed and/or the acceleration of the vehicle 1 is derived, and the steering means 20 is controlled to achieve the derived steering angle. At this time, the steering angle may be derived, using pattern data of the speed and/or the acceleration and the steering angle of each wheel 30, stored in the memory 14. As a result, it is possible to efficiently perform deceleration according to the speed and/or the acceleration of the vehicle 1.

The control unit 10 may control the steering means 20 so that the steering angle of each of the pair of wheels 30A and 30B increases with respect to the traveling direction of the vehicle 1, as the speed of the vehicle 1 is smaller.

Furthermore, when the speed of the vehicle 1 is larger than a predetermined threshold, even if the control unit 10 detects or generates the information regarding the deceleration, the control unit 10 may control the steering means 20 so as not to change the steering angle of each wheel 30.

In this way, when the vehicle 1 is traveling at high speed, a conventional brake mechanism is used for deceleration. When the vehicle 1 is traveling at a low speed that is the predetermined threshold or less, for example, 30 km/h or the like, the efficiency brake may be operated. Furthermore, as the speed is lowered, by increasing the angle of the wheel with respect to the traveling direction, the frictional force may greatly act at a lower speed. As a result, both of stability of traveling and efficient deceleration can be achieved.

Furthermore, when the acceleration of the vehicle 1 is larger than the predetermined threshold, the control unit 10 may control the steering means 20 so that the steering angle of each of the pair of wheels 30A or 30B increases with respect to the traveling direction of the vehicle 1. As a result, for example, by operating the efficiency brake at the time of an accident such as a rear-end collision and stopping the vehicle 1 at a short distance, it can be expected to reduce a possibility that multiple rear-end accidents occur.

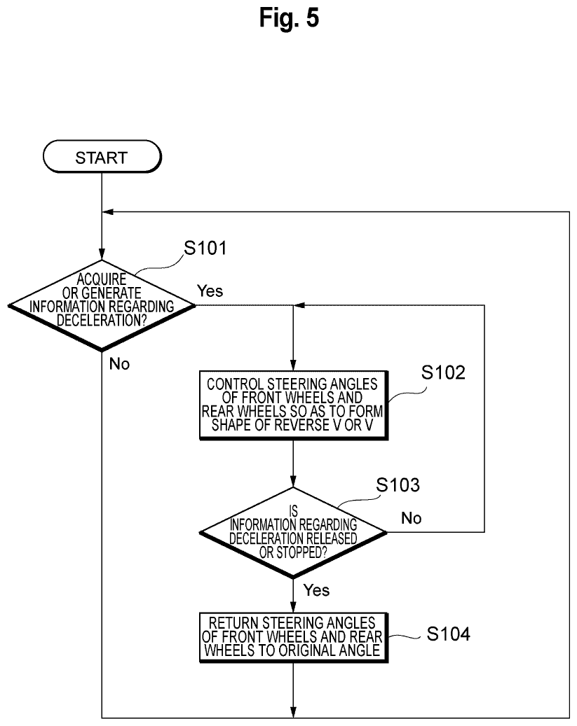

FIG. 5 is a flowchart showing an example of a processing procedure of the vehicle 1 on which the efficiency brake system is mounted.

The control unit 10 determines whether or not the information regarding the deceleration is acquired or generated, during traveling of the vehicle 1 (step S101). For example, the control unit 10 may determine whether or not the information regarding the deceleration of the vehicle 1 is acquired from the first sensor 40. Furthermore, the control unit 10 may determine whether or not the information regarding the deceleration is generated based on the information acquired from the first sensor 40 and/or the second sensor 50.

If the information regarding the deceleration is not acquired or generated (step S101: No), the control unit 10 continues traveling.

If the information regarding the deceleration is acquired or generated (step S101: Yes), the control unit 10 operates the efficiency brake. For example, the steering angle of each wheel 30 is set and controlled so as to be the steering angle shown in FIG. 3 or 4, using the steering means 20 (step S102).

While the vehicle 1 does not stop and the information regarding the deceleration is acquired or the information regarding the deceleration is generated (step S103: No), the control unit 10 operates the efficiency brake (S102).

When the information regarding the deceleration is released (that is, when information regarding deceleration is not acquired or when information regarding deceleration is not generated) or when the vehicle 1 stops (step S103: Yes), the control unit 10 controls the steering means 20 so as to release the operation of the efficiency brake, return the steering angle of the wheel 30 to an original location and to be the same direction as the traveling direction (step S104).

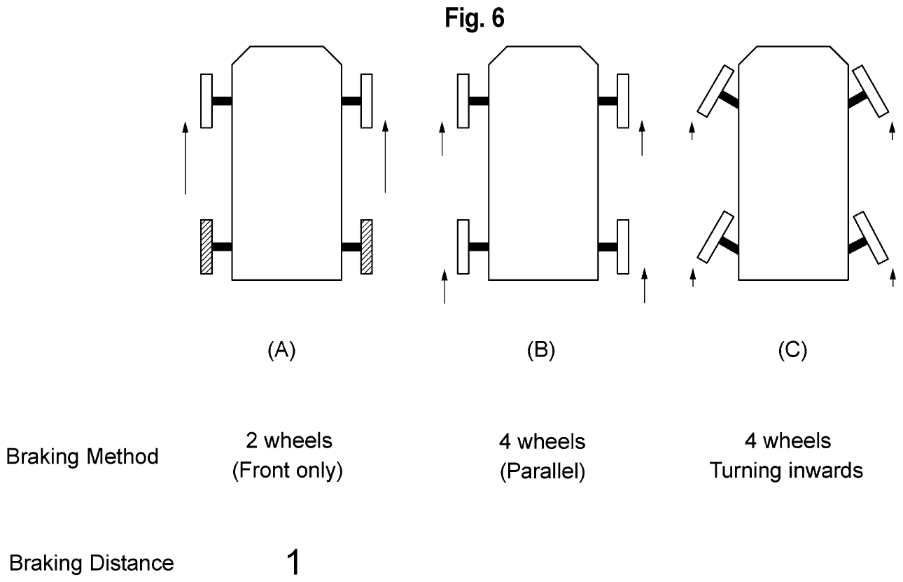

FIG. 6 is a diagram in which the efficiency brake according to the present embodiment and a conventional brake are compared with each other. FIG. 6(A) is a diagram showing a brake mechanism of a conventional two-wheel drive vehicle (front wheel drive vehicle). The two-wheel drive vehicle (front wheel drive vehicle) is a mechanism that decelerates only two wheels (front wheels) that are drive wheels.

FIG. 6(B) is a diagram showing a brake mechanism of a conventional four-wheel drive vehicle. The four-wheel drive vehicle is a mechanism that decelerates all wheels (four wheels) that are drive wheels. For example, the HUB motor can brake all the four wheels. Since the four-wheel drive vehicle can obtain deceleration power twice of the two-wheel drive vehicle, the four-wheel drive vehicle can stop the vehicle 1 at a distance of about a half of the two-wheel drive vehicle.

FIG. 6(C) is a diagram showing the efficiency brake according to the present embodiment. In addition to a normal brake mechanism, the efficiency brake performs deceleration by further setting angles of tires to form the shape of reverse “V”. Therefore, since deceleration power four time of the two-wheel drive vehicle is obtained, it is possible to stop the vehicle 1 at a distance of about ¼, as compared with the two-wheel drive vehicle.

As described above, by using the efficiency brake that performs deceleration by changing the angles of the wheels, it is possible to decelerate the vehicle faster and at a shorter distance.

### (2) Second Embodiment

A vehicle is required to stop at a particularly short distance when it is necessary to prevent an accident, such as a case where a collision or rear-end collision is avoided or an erroneous operation is performed.

Therefore, an object of the present invention is to provide a brake system that prevents occurrence of an accident.

An efficiency brake system according to one aspect of the present invention includes at least a pair of wheels positioned substantially symmetrically on the left and right of a vehicle, steering means that can individually control a steering angle of each of the pair of wheels, a sensor that detects an acceleration of the vehicle, and a control unit that controls the steering means in a case where the acceleration of the vehicle satisfies a first condition and changes the steering angle of each wheel with respect to a traveling direction of the vehicle.

According to the present invention, it is possible to provide a brake system that can prevent occurrence of an accident.

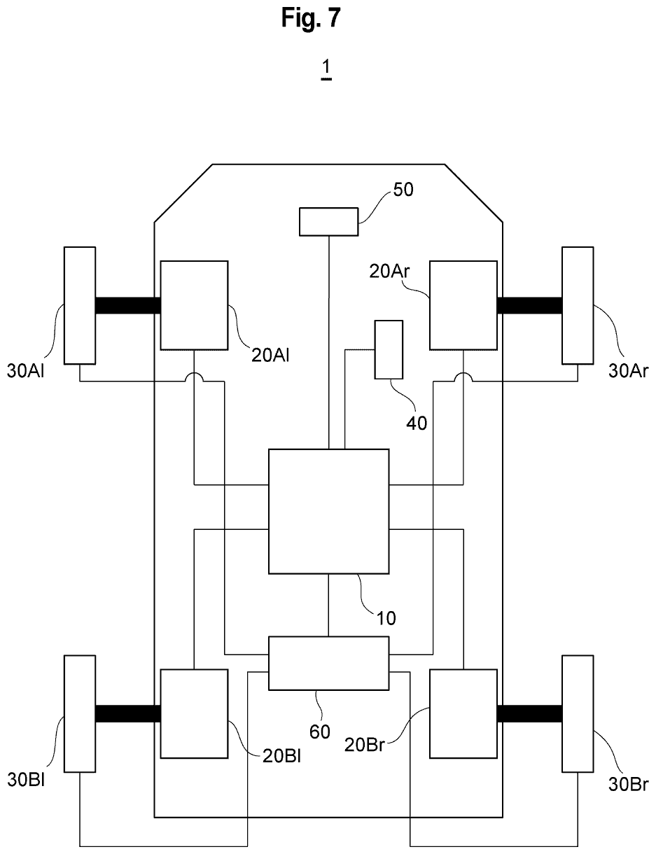

FIG. 7 is a diagram showing an example of a system configuration of a vehicle 1 on which an efficiency brake system according to the present embodiment is mounted. The vehicle 1 shown in FIG. 7 includes a control unit 10, steering means 20, wheels 30, a first sensor 40, a second sensor 50, and brake means 60. Furthermore, although not shown, various components constituting a conventional vehicle may be included. The vehicle 1 has an automatic driving function for assisting automatic driving of the vehicle 1, in addition to a manual driving function in which a driver drives the vehicle 1, and each driving mode can be arbitrarily selected.

The control unit 10 can cause the steering means 20 to control a steering angle of the wheel 30, using various types of information acquired from inside and outside of the vehicle 1. Here, the steering angle is an angle of the wheel 30 with respect to the traveling direction of the vehicle 1. For example, the control unit 10 instructs the steering angle of the wheel 30, to the steering means 20, based on information detected by the first sensor 40 and/or the second sensor 50. At this time, the control unit 10 can acquire information regarding deceleration of the vehicle 1 by a brake from the first sensor 40. Furthermore, the control unit 10 can acquire information regarding a speed or an acceleration of the vehicle 1 from the second sensor 50.

The steering means 20 can individually control the steering angle of each wheel 30, based on the instruction received from the control unit 10. In the present embodiment, as the steering means 20, steering means 20Ar, 20Al, 20Br, and 20Bl respectively corresponding to four wheels 30Ar, 30Al, 30Br, and 30Bl included in the vehicle 1 are included, and each of the steering means 20Ar, 20Al, 20Br, and 20Bl may be configured to individually set and control a steering angle of each of the wheels 30Ar, 30Al, 30Br, and 30Bl.

The vehicle 1 includes at least a pair of wheels 30, and the wheels 30 are substantially symmetrically arranged on the left and right of the vehicle 1. In the present embodiment, the vehicle 1 includes four wheels, that is, a pair of right and left front wheels 30A (30Ar and 30Al) and a pair of right and left rear wheels 30B (30Br and 30Bl).

A HUB motor (hub motor) that is an electric motor mounted in a hub may be mounted on each wheel 30. Note that, even if the motor itself is not mounted in the hub, a motor (in wheel motor (IWM) ) in which a driving force of the electric motor is directly transmitted to the wheel may be mounted. The HUB motor is mounted on all the four wheels, a movement of each of the wheels 30 can be individually controlled. Therefore, this is preferable to realize an efficiency brake that changes angles of the wheels and performs deceleration.

The first sensor 40 detects information regarding the brake by the brake means 60. For example, the first sensor 40 detects braking of the wheel 30 is activated by the brake means 60, by a brake operation by a driver or automatic driving control, and transmits the detected information to the control unit 10.

The second sensor 50 may be various sensors mounted on the vehicle 1. For example, the second sensor 50 may be a speed sensor or an acceleration sensor. The second sensor 50 transmits detected information to the control unit 10.

The brake means 60 can brake each wheel 30, based on the instruction received from the control unit 10. The brake means 60 may include, for example, a wheel cylinder (not shown) provided on each of the wheels 30Ar, 30Al, 30Br, and 30Bl, a brake actuator (not shown) connected to the wheel cylinder, and the like. The brake actuator brakes each of the wheels 30Ar, 30Al, 30Br, and 30Bl by controlling a brake pressure generated by a hydraulic pump or the like driven by a motor to an arbitrary magnitude and supplying the brake pressure to the wheel cylinder. In a case of detecting that the driver steps on a brake pedal, the control unit 10 may issue an instruction to the brake means 60 to brake the wheel 30, or may issue an instruction to the brake means 60 to brake the wheel 30 by automatic driving control.

Since a configuration of the control unit 10 according to the present embodiment is similar to that in FIG. 2, illustration is omitted.

The control unit 10 includes, for example, a processor 12 and a memory 14.

The processor 12 controls an operation of the entire vehicle 1. As the processor 12, for example, a central processing unit (CPU), a micro processing unit (MPU), a field programmable gate array (FPGA), a microcomputer (microcontroller), or the like can be used. The processor 12 functions as a control unit that controls the operation of the entire vehicle 1, by executing a program stored in the memory 14.

The memory 14 stores various programs to be executed by the processor 12 and various types of data. The memory 14 may include, for example, a volatile storage device such as a read only memory (ROM) or a random access memory (RAM) and a nonvolatile storage device such as a hard disk drive (HDD) or a flash memory. Various types of data includes, for example, pattern data of a steering angle of each of the four wheels 30Ar, 30Al, 30Br, and 30Bl when the efficiency brake is used and condition data for operating the efficiency brake (for example, threshold of vehicle speed or the like).

Furthermore, the memory 14 stores information regarding a characteristic signal (pulse signal or the like) that may be included in data of the acceleration of the vehicle 1 acquired via the second sensor 50, in a case where an accident such as sudden acceleration, sudden braking, or sudden steering occurs.

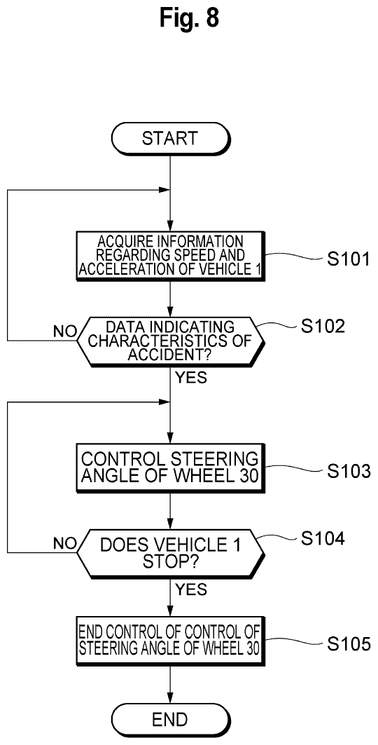

FIG. 8 is a flowchart showing an example of a processing procedure of the vehicle 1 on which the efficiency brake system is mounted.

While the vehicle 1 is traveling, the control unit 10 acquires information regarding a change in the speed and the acceleration of the vehicle 1 from the second sensor 50 (step S101). The control unit 10 determines whether or not a signal indicating a sign of an accident such as sudden acceleration, sudden braking, or sudden steering is included in data of the acceleration (whether or not to satisfy first condition) (step S102). For example, the control unit 10 makes a determination by comparing characteristics of the acceleration data with the sign of the accident stored in the memory 14. Furthermore, the control unit 10 may make a determination by determining whether or not an absolute value of the acceleration of the vehicle 1 exceeds a predetermined threshold. Furthermore, the determination may be made by using a machine learning model that has learned characteristics of the acceleration data indicating the sign of the accident.

In a case where it is determined that the acceleration data includes the signal indicating the sign of the accident (step S102: YES), the control unit 10 outputs an instruction to the steering means 20 and controls the steering angle of the wheel 30 (step S103).

The control of the steering angle of the wheel 30 by the steering means 20 will be described with reference to FIGS. 3 and 4. In the examples shown in FIGS. 3 and 4, the vehicle 1 can individually control the steering angles of all the four wheels 30Ar, 30Al, 30Br, and 30Bl by the corresponding steering means 20Ar, 20Al, 20Br, and 20Bl. The deceleration by the brake means 20 is performed by braking rotation of the wheel 30. However, the steering means 20 cancels a moment toward the traveling direction to perform the deceleration, by changing the steering angle of each of the four wheels.

For example, as shown in FIG. 3, the control unit 10 may control the steering angles so that each of the front wheels 30Ar and 30Al and the rear wheels 30Br and 30Bl form the shape of reverse “V”, as viewed from an upper surface of the vehicle 1, using the steering means 20. That is, the control unit 10 controls the steering angle so that the right-side wheel 30Ar faces leftward and the left-side wheel 30Al faces rightward, using the steering means 20. Furthermore, the control unit 10 controls the steering angle so that the right-side wheel 30Br faces leftward and the left-side wheel 30Bl faces rightward, using the steering means 20.

Furthermore, as shown in FIG. 4, the control unit 10 may control the steering angles so that each of the front wheels 30Ar and 30Al and the rear wheels 30Br and 30Bl form the shape of “V”, as viewed from the upper surface of the vehicle 1, using the steering means 20. That is, the control unit 10 controls the steering angle so that the right-side wheel 30Ar faces rightward and the left-side wheel 30Al faces leftward, using the steering means 20. Furthermore, the control unit 10 controls the steering angle so that the right-side wheel 30Br faces rightward and the left-side wheel 30Bl faces leftward, using the steering means 20.

In this way, by narrowing a traveling direction side of the pairs of left and right wheels 30A and 30B toward the inner side or widening the traveling direction side to the outer side, using the steering means 20, a frictional force on a contact surface between the wheel 30 and the ground is increased, and the deceleration is realized. Note that the steering angles may be set so that the front wheels 30Ar and 30Al form the shape of reverse “V” and the rear wheels 30Br and 30Bl form the shape of “V”, or the steering angles may be set so that the front wheels 30Ar and 30Al form the shape of “V” and the rear wheels 30Br and 30Bl form the shape of reverse “V”.

The control unit 10 may control the steering means 20 so that the steering angle of the wheel 30 becomes an angle according to the acceleration of the vehicle 1. Specifically, as the angle of the wheel 30 with respect to the traveling direction increases (that is, as narrowing traveling direction side in a case of shape of reverse “V” or as widening traveling direction side in a case of the shape of “V”), the frictional force with respect to the ground increases, and an effect of the deceleration increases.

The control unit 10 can shorten a time period until the deceleration, by controlling the angle of the wheel 30 with respect to the traveling direction to be larger as the acceleration of the vehicle 1 is larger. As a result, for example, at the time of an accident such as a rear-end accident, by stopping the vehicle 1 at a short distance, it can be expected to prevent occurrence of multiple rear-end accidents. Note that the control unit 10 may derive the steering angle using the acceleration data indicating the sign of the accident, stored in the memory 14. In this way, by detecting and coping with the sign of the accident in the acceleration data, the occurrence of the accident can be prevented or suppressed. Moreover, at the time when the accident occurs (when occurrence of accident is detected in acceleration data), by immediately stopping the vehicle 1, expansion and a chain of accidents can be prevented and suppressed.

Furthermore, the control unit 10 may control the steering means 20 so that the steering angles of the right-side wheels 30Ar and 30Br and the steering angles of the left-side wheels 30Al and 30Bl are substantially identical to each other. That is, the steering means 20 may be controlled so that an angle formed by the traveling direction of the vehicle 1 and a rotation surface of the wheel 30Ar or 30Br and an angle formed by the traveling direction of the vehicle 1 and a rotation surface of the wheel 30Al or 30Bl are substantially identical to each other. As a result, the frictional forces acting on the left and right wheels are substantially identical to each other, and it can be expected that steering at the time of deceleration is stabilized.

Furthermore, in a case where it is determined from the characteristics of the acceleration data that spinning has occurred, the control unit 10 may set the direction of each wheel 30 to face inward or outward by a predetermined angle with respect to a rotation direction of spinning. That is, by setting the direction of each wheel 30 to be inclined by a direction +α (predetermined angle) orthogonal to the center of gravity of the vehicle, a frictional force against the rotation may be generated to suppress spinning.

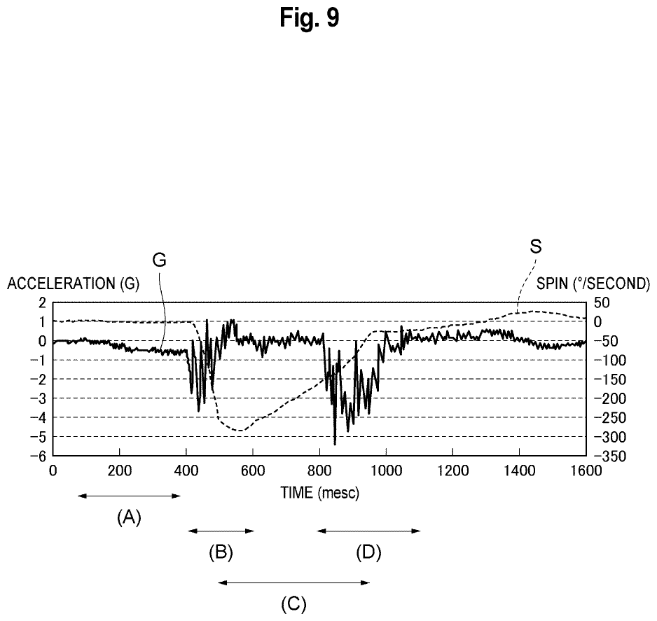

FIG. 9 is a diagram showing a waveform (G) and a spin waveform(S) of an acceleration when a collision accident occurs during traveling of the vehicle. Note that FIG. 9 is cited from an accident analysis report (http://re-www.datatec.jp/product/report/kaiseki_2.html) of Datatec Basic Theory Laboratory. The acceleration waveform G in a section shown as (A) in FIG. 9 shows that a brake operation has performed to avoid a collision. Furthermore, the acceleration waveform G in a section (B) shows that a collision (side collision) has occurred. Furthermore, in a section (C), the spin waveform C shows that spinning has occurred due to a side collision. Moreover, the acceleration waveform G in a section (D) shows that a collision has occurred again.

The control unit 10 may control the wheel 30 according to an occurred event, using the acceleration waveform and the spin waveform as shown in FIG. 9. For example, when the acceleration waveform caused by the brake operation as shown in the section (A) is detected, the occurrence of the collision can be avoided, by controlling the steering means 20 so as to immediately stop the vehicle 1. Furthermore, when the spin waveform in the section (C) is detected, the collision caused by spinning can be avoided, by controlling the wheel 30 to face inward or outward of the rotation direction of spinning.

Until the vehicle 1 stops (step S104), the control unit 10 controls the steering angle of the wheel 30. When the vehicle 1 stops (step S104: YES), the control unit 10 ends the control of the steering means 20 (step S105).

Note that, the control unit 10 may set the steering angle of each wheel 30, according to the speed and/or the acceleration of the vehicle 1. For example, the control unit 10 acquires the speed and/or the acceleration based on the information detected by the second sensor 50. Then, the steering angle suitable for the speed and/or the acceleration of the vehicle 1 is derived, and the steering means 20 is controlled to achieve the derived steering angle. At this time, the steering angle may be derived, using the pattern data of the speed and/or the acceleration and the steering angle of each wheel 30, stored in the memory 14. As a result, it is possible to efficiently perform deceleration according to the speed and/or the acceleration of the vehicle 1.

As described above, according to the present embodiment, in a case where the speed or the acceleration of the vehicle 1 during traveling of the vehicle 1 satisfies a predetermined condition indicating the sign of the accident, such as sudden acceleration, deceleration, or the like, the control unit 10 outputs an instruction to the steering means 20 and changes the steering angle of the wheel 30, and the moment toward the traveling direction is canceled so that the vehicle 1 stops as quickly as possible. As a result, it is possible to prevent occurrence of an accident such as a collision or a rear-end collision.

### (3) Third Embodiment

An antilock brake system (ABS) has been known that prevents a wheel from being locked by reducing a braking force of the wheel when any one wheel during braking tends to be locked and shortens a braking distance to stop.

Normally, when any one wheel during braking tends to be locked, the ABS is operated, and a brake pressure is controlled (by repeating depressurization or pressurization or the like). However, only by controlling the brake pressure, there has been a case where the braking distance to stop cannot be sufficiently shortened.

Therefore, an object of the present invention is to provide a brake system that can sufficiently shorten a braking distance to stop.

An efficiency brake system according to one aspect of the present invention includes at least a pair of wheels positioned substantially symmetrically on the left and right of a vehicle, steering means that can individually control a steering angle of each of the pair of wheels, brake means that generates a braking force in the pair of wheels, and a control unit that controls the steering means and the brake means, in which the control unit controls the brake means so that the braking force on the pair of wheels is reduced in a case of determining that any one wheel during braking tends to be locked and controls the steering means so that the pair of wheels form a shape of substantially reverse V as viewed from an upper surface of the vehicle.

According to the present invention, it is possible to sufficiently shorten the braking distance to stop.

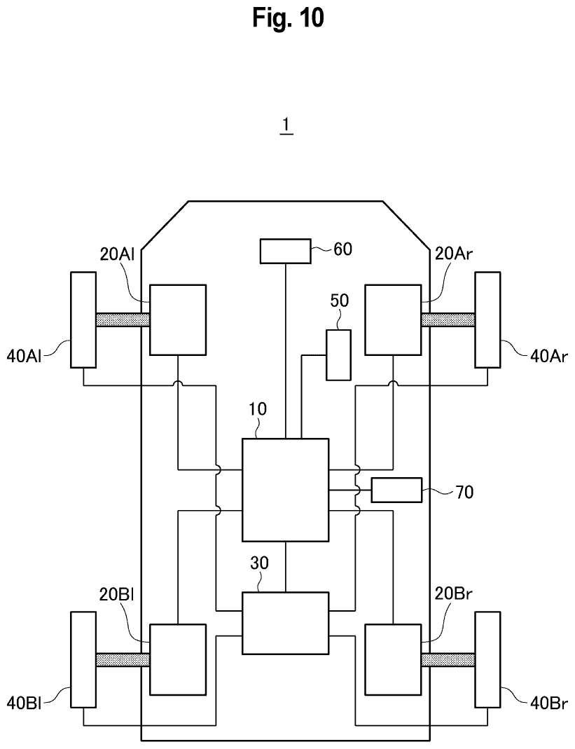

FIG. 10 is a diagram showing an example of a system configuration of a vehicle 1 on which an efficiency brake system according to the present embodiment is mounted. In order to solve the problem of the conventional ABS, when any one wheel during braking tends to be locked, the efficiency brake system not only controls a brake pressure but also efficiently perform deceleration by changing an angle of each wheel so that it is possible to prevent locking of the wheel and sufficiently shorten a braking distance to stop. Note that, in the following description, the brake method using the efficiency brake system is referred to as an “efficiency brake”.

The vehicle 1 shown in FIG. 10 includes a control unit 10, steering means 20, brake means 30, wheels 40, a first sensor 50, a second sensor 60, and notification means 70. Furthermore, although not shown, various components constituting a conventional vehicle may be included. The vehicle 1 has an automatic driving function for assisting automatic driving of the vehicle 1, in addition to a manual driving function in which a driver drives the vehicle 1, and each driving function may be arbitrarily selected.

The control unit 10 performs control regarding the efficiency brake, using various types of information acquired from inside and outside of the vehicle 1. For example, the control unit 10 instructs a steering angle of the wheel 40 to the steering means 20 or instructs a braking force of the wheel 40 to the brake means 30, based on the information detected by the first sensor 50 and/or the second sensor 60.

At this time, the control unit 10 may acquire information regarding the brake of the vehicle 1 from the first sensor 50 and acquire information regarding a wheel speed from the second sensor 60.

The steering means 20 can individually control the steering angle of each wheel 40, based on the instruction received from the control unit 10. As the steering means 20, steering means 20Ar, 20Al, 20Br, and 20Bl respectively corresponding to four wheels 40Ar, 40Al, 40Br, and 40Bl included in the vehicle 1 are included, and each of the steering means 20Ar, 20Al, 20Br, and 20Bl may be configured to individually set and control a steering angle of each of the wheels 40Ar, 40Al, 40Br, and 40Bl.

The brake means 30 can brake each wheel 40, based on the instruction received from the control unit 10. The brake means 30 may include, for example, a wheel cylinder (not shown) provided on each of the wheels 40Ar, 40Al, 40Br, and 40Bl, a brake actuator (not shown) connected to the wheel cylinder, and the like. The brake actuator brakes each of the wheels 40Ar, 40Al, 40Br, and 40Bl by controlling a brake pressure generated by a hydraulic pump or the like driven by a motor to an arbitrary magnitude and supplying the brake pressure to the wheel cylinder.

The vehicle 1 includes at least a pair of wheels, and the wheels are substantially symmetrically arranged on the left and right of the vehicle 1. In the present embodiment, the vehicle 1 includes four wheels, that is, a pair of right and left front wheels 40A (40Ar and 40Al) and a pair of right and left rear wheels 40B (40Br and 40Bl).

A hub motor (HUB motor) may be mounted on the wheel 40. The HUB motor may also be referred to as an in wheel motor (IWM). The HUB motor is mounted on all the four wheels, a movement of each of the wheels 40 can be individually controlled. Therefore, this is preferable to realize an efficiency brake that changes angles of the wheels and performs deceleration.

The first sensor 50 detects information regarding a brake. For example, when a brake pedal is operated by a driver, the first sensor 50 transmits information indicating an operation amount (that is, stroke amount) of the brake pedal or the like to the control unit 10.

The second sensor 60 may be various sensors mounted on the vehicle 1. For example, the second sensor 60 may include a wheel speed sensor provided in each of the wheels 40Ar, 40Al, 40Br, and 40Bl or the like, in addition to a speed sensor and an acceleration sensor. The second sensor 60 transmits information such as a speed, an acceleration, or a wheel speed of the vehicle 1 sequentially detected, to the control unit 10.

The notification means 70 notifies the driver of a predetermined alarm in a case where the efficiency brake is operated. For example, the notification means 70 may be buzzer or a lamp provided in an instrument panel (not shown). Note that, in a case where the plurality of notification means is provided in the vehicle 1, these notification means may be simultaneously operated.

Since a configuration of the control unit 10 according to the present embodiment is similar to that in FIG. 2, illustration is omitted. The control unit 10 includes, for example, a processor 12 and a memory 14.

The processor 12 performs control regarding the efficiency brake of the vehicle 1. As the processor 12, for example, a central processing unit (CPU), a micro processing unit (MPU), a field programmable gate array (FPGA), a microcomputer (microcontroller), or the like can be used. The processor 12 functions as a control unit, by executing a program stored in the memory 14.

The memory 14 stores various programs to be executed by the processor 12 and various types of data. The memory 14 may include, for example, a volatile storage device such as a read only memory (ROM) or a random access memory (RAM) and a nonvolatile storage device such as a hard disk drive (HDD) or a flash memory.

Various types of data includes, for example, pattern data of the steering angle of each of the four wheels 40Ar, 40Al, 40Br, and 40Bl when the efficiency brake is used and condition data for operating the efficiency brake (for example, threshold of vehicle speed, wheel speed, or the like).

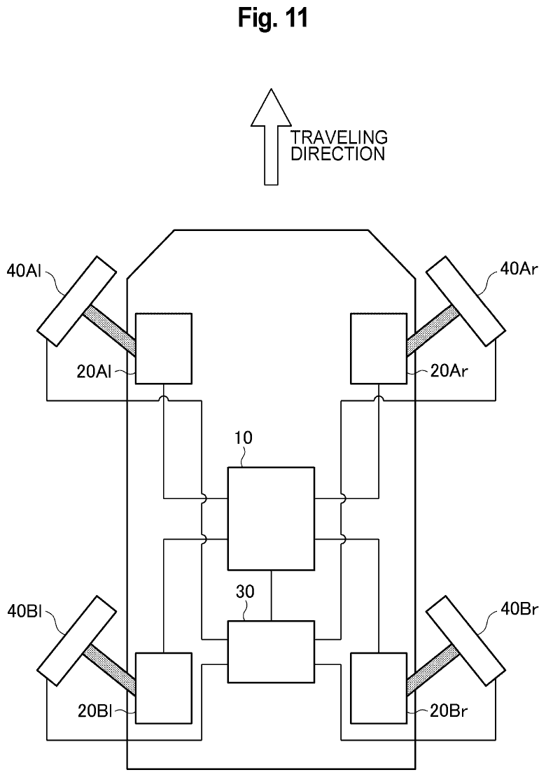

FIGS. 11 to 13 are diagrams showing an example of an operation mode of the efficiency brake according to the present embodiment.

In the present embodiment, it is possible to freely control the steering angles of all the four wheels. Therefore, by controlling the brake pressure and controlling the steering angle of the wheel to cancel a moment toward a traveling direction, the efficiency brake is realized.

In the vehicle 1 that is steerable by all the four wheels, for example, when it is detected that any one wheel during braking starts to tend to be locked, the control unit 10 controls the brake means 30 and controls the brake pressure, so as to reduce the braking force of the wheel. Moreover, for example, as shown in FIG. 11, the control unit 10 controls the steering angles so that the pair of front wheels 40A and the pair of rear wheels 40B form the shape of reverse “V”, as viewed from the upper surface of the vehicle, using the steering means 20. That is, the control unit 10 controls the steering angles so that the right-side wheel 40Ar faces leftward and the left-side wheel 40Al faces rightward, of the pair of front wheels 40A, using the steering means 20. Furthermore, the control unit 10 controls the steering angles so that the right-side wheel 40Br faces leftward and the left-side wheel 40Bl faces rightward, of the pair of rear wheels 40B, using the steering means 20. Note that whether or not any one wheel starts to tend to be locked can be detected, for example, by comparing the wheel speeds detected by the wheel speed sensors provided in the respective wheels 40, or the like.

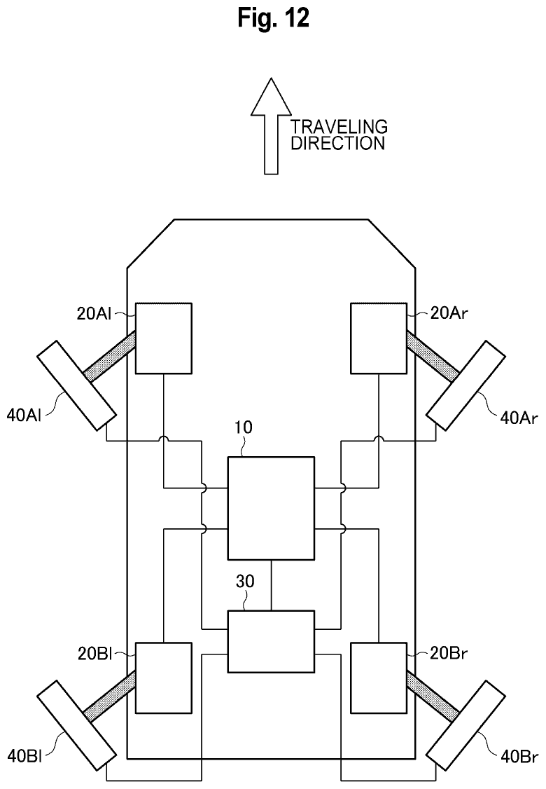

In FIG. 11, an aspect is shown in which the steering angles are controlled so that each of the pair of front wheels 40A and the pair of rear wheels 40B form the shape of reverse “V”, as viewed from the upper surface of the vehicle, using the steering means 20. However, for example, as shown in FIG. 12, the steering angles may be controlled so that each of the pair of front wheels 40A and the pair of rear wheels 40B form the shape of “V”, as viewed from the upper surface of the vehicle. That is, the control unit 10 controls the steering angles so that the right-side wheel 40Ar faces rightward and the left-side wheel 40Al faces leftward, of the pair of front wheels 40A, using the steering means 20. Furthermore, the control unit 10 controls the steering angles so as to face the right-side wheel 40Br rightward and face the left-side wheel 40Bl leftward, of the pair of rear wheels 40B, using the steering means 20.

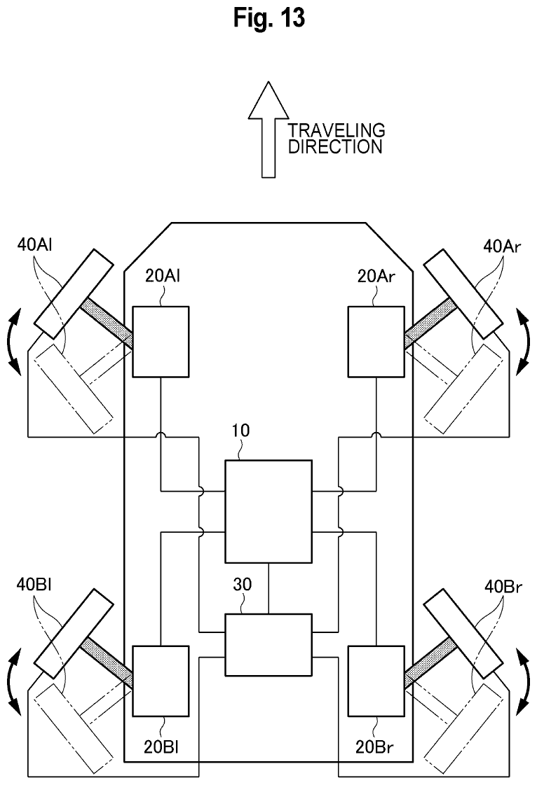

Moreover, as another aspect, for example, as shown in FIG. 13, the control unit 10 may alternately switch, at a predetermined timing, a first steering mode in which the steering angles are controlled so that the pair of left and right wheels 40A and 40B form the shape of reverse “V”, as viewed from the upper surface of the vehicle and a second steering mode in which the steering angles are controlled so that the pair of left and right wheels 40A and 40B form the shape of “V”, as viewed from the upper surface of the vehicle. At this time, it is sufficient for the control unit 10 to derive a steering mode switching timing to enable to avoid locking of the wheel 40 and shorten the braking distance while securing the maximum braking force, based on various information obtained from the first sensor 50 and the second sensor 60.

In this way, in the efficiency brake system according to the present embodiment, when it is detected that any one wheel 40 during braking starts to tend to be locked, a frictional force on a contact surface between the wheel 40 and the ground is increased, by not only simply controlling the brake pressure, but also by narrowing a traveling direction side of the pair of left and right wheels 40A and 40B inward or widening the traveling direction side outward. As a result, locking of the wheel 40 can be prevented, and it is possible to sufficiently shorten the braking distance to stop. At this time, the control unit 10 can adjust the frictional force between the wheel 40 and the ground, by adjusting the steering angle of the wheel 40.

Furthermore, the control unit 10 may set the steering angles so that the front wheels 40A form the shape of reverse “V” and the rear wheels 40B form the shape of “V”, using the steering means 20. Furthermore, the control unit 10 may set the steering angles so that the front wheels 40A form the shape of “V” and the rear wheels 40B form the shape of reverse “V”, using the steering means 20.

The control unit 10 may control the steering means 20 so that an angle between the traveling direction of the vehicle 1 and the steering angle of the right-side wheel 40Ar or 40Br, among the pair of wheels 40A and 40B and an angle between the traveling direction of the vehicle 1 and the steering angle of the left-side wheel 40Al or 40Bl are substantially identical to each other. That is, the steering means 20 may be controlled so that an angle formed by the traveling direction of the vehicle 1 and a rotation surface of the wheel 40Ar or 40Br and an angle formed by the traveling direction of the vehicle 1 and a rotation surface of the wheel 40Al or 40Bl are substantially identical to each other. As a result, the frictional forces acting on the left and right wheels are substantially identical to each other, and it can be expected that steering at the time of deceleration is stabilized.

Furthermore, the control unit 10 may set the steering angle of each wheel 40, according to the speed and/or the acceleration of the vehicle 1. For example, the control unit 10 acquires the speed and/or the acceleration based on the information detected by the second sensor 60. Then, the steering angle suitable for the speed and/or the acceleration of the vehicle 1 is derived, and the steering means 20 is controlled to achieve the derived steering angle. At this time, the steering angle may be derived, using pattern data of the speed and/or the acceleration and the steering angle of each wheel 40, stored in the memory 14. As a result, it is possible to efficiently perform deceleration according to the speed and/or the acceleration of the vehicle 1.

Furthermore, the control unit 10 may control the steering means 20 so that the steering angle of each of the pair of wheels 40A and 40B increases with respect to the traveling direction of the vehicle 1, as the speed of the vehicle 1 is lower.

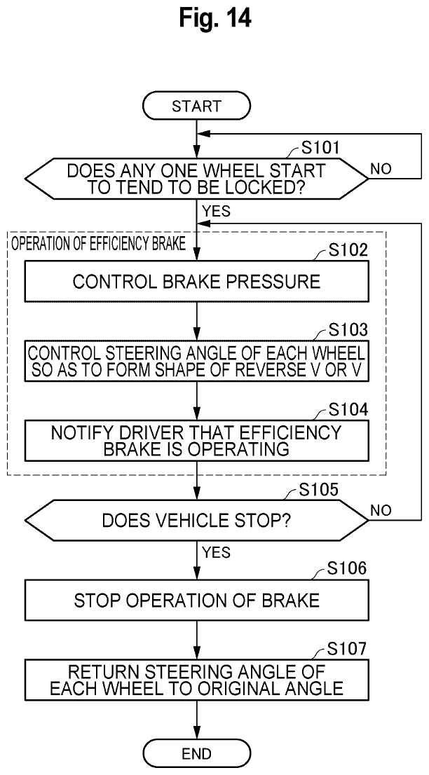

FIG. 14 is a flowchart showing an example of a processing procedure of the vehicle 1 on which the efficiency brake system is mounted.

The control unit 10 determines (detects) whether or not any one wheel 40 starts to tend to be locked, by comparing the wheel speeds detected by the wheel speed sensors provided in the respective wheels 40 (step S101).

In a case of determining that no wheel 40 starts to tend to be locked (step S101: NO), the control unit 10 continues normal driving, without operating the efficiency brake.

On the other hand, when determining that any one wheel 40 starts to tend to be locked (step S101: YES), the control unit 10 operates the efficiency brake. Specifically, the control unit 10 instructs the brake means 30 to control the brake pressure, to prevent locking of the wheel 40 (step S102). The control unit 10 instructs the steering means 20 to control the steering angle of the wheel 40, in the aspect shown in any one of FIGS. 11 to 13 (step S103). Moreover, the control unit 10 notifies the notification means 70 of a predetermined alarm, in order to inform a driver of that the efficiency brake is operating (step S104).

The control unit 10 operates the efficiency brake (step S102-S103-S104) before the vehicle 1 stops (step S105: NO).

Thereafter, when detecting that the vehicle 1 stops (step S105: YES), the control unit 10 ends the notification of the predetermined alarm, stops operations of all brakes including the efficiency brake (step S106), and performs control to return the steering angle of the wheel 40 to be the same direction as the traveling direction (step S107), and then, ends the processing.

As described above, in a case where any one wheel during braking starts to tend to be locked, not only by simply controlling the brake pressure, but also controlling the angle of the wheel, it is possible to prevent locking of the wheel and sufficiently shorten the braking distance to stop.

### (4) Fourth Embodiment

An automatic braking device has been known that detects a distance between an own vehicle and an obstacle on a front side and a relative speed, and automatically operates a brake and suddenly brakes the own vehicle, in a case where the own vehicle abnormally approaches the obstacle on the front side, from the detection result.

The automatic braking device is effective in preventing the own vehicle and the obstacle on the front side from approaching too close to each other. However, there has been a problem in that, in a case where a rear vehicle exists, when the automatic braking device applies sudden braking, there is a possibility that sudden braking is too later and the rear vehicle collides.

Therefore, an object of the present invention is to provide a brake system that can perform optimal brake control according to a situation surrounding an own vehicle.

A brake system according to one aspect of the present invention includes at least a pair of wheels positioned substantially symmetrically on the left and right of a vehicle, steering means that can individually control a steering angle of each of the pair of wheels, brake means that generates a braking force in the pair of wheels, a first acquisition unit that acquires brake operation information regarding a brake operation of the vehicle, a second acquisition unit that acquires surrounding environment information regarding a surrounding environment of the vehicle, and a control unit that controls the steering means and the brake means, in which the control unit selects one of a normal brake for braking the vehicle by controlling the brake means based on the brake operation information and the surrounding environment information and an efficiency brake for braking the vehicle by controlling the brake means and the steering means.

According to the present invention, it is possible to perform optimal brake control according to the situation surrounding the own vehicle.

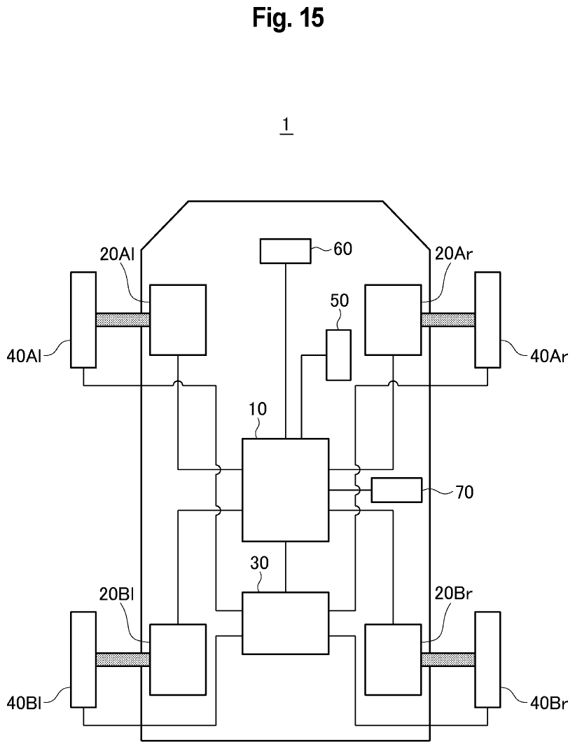

FIG. 15 is a diagram showing an example of a system configuration of the vehicle 1 on which the brake system according to the present embodiment is mounted. The brake system according to the present embodiment can operate two types of brakes including a “normal brake” for braking the vehicle by controlling a brake pressure and an “efficiency brake” for efficiently performing deceleration and braking the vehicle, not only by controlling the brake pressure but also changing an angle of each wheel. The vehicle 1 shown in FIG. 1 includes a control unit 10, steering means 20, brake means 30, wheels 40, a first sensor 50, a second sensor 60, and notification means 70. Furthermore, although not shown, various components constituting a conventional vehicle may be included. The vehicle 1 has an automatic driving function for assisting automatic driving of the vehicle 1, in addition to a manual driving function in which a driver drives the vehicle 1, and each driving function may be arbitrarily selected.

The control unit 10 performs various control regarding a brake, using various types of information acquired from inside and outside of the vehicle 1. For example, the control unit 10 selects a type of the brake (specifically, normal brake or efficiency brake), based on information detected by the first sensor 50 and the second sensor 60 and instructs a steering angle of the wheel 40 to the steering means 20 or instructs a braking force of the wheel 40 to the brake means 30, according to the selected type of brake.

The steering means 20 can individually control the steering angle of each wheel 40, based on the instruction received from the control unit 10. As the steering means 20, steering means 20Ar, 20Al, 20Br, and 20Bl respectively corresponding to four wheels 40Ar, 40Al, 40Br, and 40Bl included in the vehicle 1 are included, and each of the steering means 20Ar, 20Al, 20Br, and 20Bl may be configured to individually set and control a steering angle of each of the wheels 40Ar, 40Al, 40Br, and 40Bl.

The brake means 30 can brake each wheel 40, based on the instruction received from the control unit 10. The brake means 30 may include, for example, a wheel cylinder (not shown) provided on each of the wheels 40Ar, 40Al, 40Br, and 40Bl, a brake actuator (not shown) connected to the wheel cylinder, and the like. The brake actuator brakes each of the wheels 40Ar, 40Al, 40Br, and 40Bl by controlling a brake pressure generated by a hydraulic pump or the like driven by a motor to an arbitrary magnitude and supplying the brake pressure to the wheel cylinder.

The vehicle 1 includes at least a pair of wheels (tires), and the wheels are substantially symmetrically arranged on the left and right of the vehicle 1. In the present embodiment, the vehicle 1 includes four wheels, that is, a pair of right and left front wheels 40A (40Ar and 40Al) and a pair of right and left rear wheels 40B (40Br and 40Bl).

A hub motor (HUB motor) may be mounted on the wheel 40. The HUB motor may also be referred to as an in wheel motor (IWM). The HUB motor is mounted on all the four wheels, a movement of each of the wheels 40 can be individually controlled. Therefore, this is preferable to realize the efficiency brake that changes angles of the wheels and performs deceleration.

The first sensor 50 detects brake operation information regarding a brake operation. The first sensor 50 includes, for example, a brake pedal sensor or the like. When a brake pedal is operated by a driver, the first sensor 50 transmits the brake operation information indicating an operation amount (that is, stroke amount) or the like of the brake pedal to the control unit (first acquisition unit) 10.

The second sensor 60 detects information regarding a surrounding environment of the own vehicle (in the present embodiment, rear vehicle information indicating inter-vehicle distance from rear vehicle, relative speed, or the like) The second sensor 60 includes, for example, a light detection and ranging (LIDAR) sensor, an ultrasonic sonar, a stereo camera, or the like. When detecting the rear vehicle information, the second sensor 60 transmits the rear vehicle information to the control unit (second acquisition unit) 10.

In addition, on the vehicle 1, various sensors including a speed sensor, an acceleration pedal sensor, a shift position sensor, and an acceleration sensor are mounted.

The notification means 70 notifies outside (driver or the like) of a brake operation state. The notification means 70 may include, for example, a buzzer, a lamp, a brake lamp, or the like provided in an instrument panel (not shown). When the brake is operated by the control unit 10, the notification means 70 may notify the driver of whether or not the brake is operated, the type of the brake in operation, or the like, for example, by a lamp color, a lighting pattern, a text message, or the like. As an example, in a case where the normal brake is in operation, a predetermined lamp in the instrument panel is blinked and displayed in yellow, and in a case where the efficiency brake is in operation, a predetermined lamp in the instrument panel is blinked and displayed in blue. In this way, the notification is performed in an aspect different according to the type of the brake in operation, the driver can accurately grasp the brake in operation. Note that, in a case where the plurality of notification means 70 is provided in the vehicle 1, a combination of the notification means to be used may be changed, according to the type of the brake in operation. Furthermore, by changing a display aspect of the brake lamp according to the type of the brake in operation, the brake operation state may be notified to the rear vehicle or the like.

Since a configuration of the control unit 10 according to the present embodiment is similar to that in FIG. 2, illustration is omitted. The control unit 10 includes, for example, a processor 12 and a memory 14.

The processor 12 performs control regarding the brake of the vehicle 1. As the processor 12, for example, a central processing unit (CPU), a micro processing unit (MPU), a field programmable gate array (FPGA), a microcomputer (microcontroller), or the like can be used. The processor 12 functions as a control unit, by executing a program stored in the memory 14.

The memory 14 stores various programs to be executed by the processor 12 and various types of data. The memory 14 may include, for example, a volatile storage device such as a read only memory (ROM) or a random access memory (RAM) and a nonvolatile storage device such as a hard disk drive (HDD) or a flash memory.

Various types of data includes a steering angle pattern indicating the respective steering angles of the four wheels 40Ar, 40Al, 40Br, and 40Bl, for example, when the efficiency brake is operated.

### Characteristics of Efficiency Brake

An example of the operation mode of the efficiency brake in the present embodiment will be described with reference to FIGS. 11 and 12.

In the present embodiment, it is possible to freely control the steering angles of all the four wheels. Therefore, by controlling the brake pressure and controlling the steering angle of the wheel to cancel a moment toward a traveling direction, the efficiency brake is realized.

In the vehicle 1 steerable by all the four wheels, when selecting the efficiency brake as an operation brake, based on the brake operation information and the rear vehicle information, first, the control unit 10 controls the brake means 30 and controls the brake pressure. Moreover, for example, as shown in FIG. 11, the control unit 10 controls the steering angles so that the pair of front wheels 40A and the pair of rear wheels 40B form the shape of reverse “V”, as viewed from the upper surface of the vehicle, using the steering means 20. That is, the control unit 10 controls the steering angles so that the right-side wheel 40Ar faces leftward and the left-side wheel 40Al faces rightward, of the pair of front wheels 40A, using the steering means 20. Furthermore, the control unit 10 controls the steering angles so that the right-side wheel 40Br faces leftward and the left-side wheel 40Bl faces rightward, of the pair of rear wheels 40B, using the steering means 20.

In FIG. 11, an aspect is shown in which the steering angles are controlled so that each of the pair of front wheels 40A and the pair of rear wheels 40B form the shape of reverse “V”, as viewed from the upper surface of the vehicle, using the steering means 20. However, for example, as shown in FIG. 12, the steering angles may be controlled so that each of the pair of front wheels 40A and the pair of rear wheels 40B form the shape of “V”, as viewed from the upper surface of the vehicle. That is, the control unit 10 controls the steering angles so that the right-side wheel 40Ar faces rightward and the left-side wheel 40Al faces leftward, of the pair of front wheels 40A, using the steering means 20. Furthermore, the control unit 10 controls the steering angles so as to face the right-side wheel 40Br rightward and face the left-side wheel 40Bl leftward, of the pair of rear wheels 40B, using the steering means 20.

In this way, in a case where the efficiency brake is operated, by narrowing a traveling direction side of the pairs of left and right wheels 40A and 40B toward the inner side or widening the traveling direction side to the outer side, not only by simply controlling the brake pressure, a frictional force on a contact surface between the wheel 40 and the ground is increased. As a result, it is possible to sufficiently shorten a braking distance to stop. At this time, the control unit 10 can adjust the frictional force between the wheel 40 and the ground, by adjusting the Steering angle of the wheel 40.

### Selection of Type of Brake

As described above, from a viewpoint of shortening the braking distance, it is desirable to select the efficiency brake. However, depending on the situation surrounding the own vehicle, there is a case where it is desirable to select the normal brake, instead of the efficiency brake.

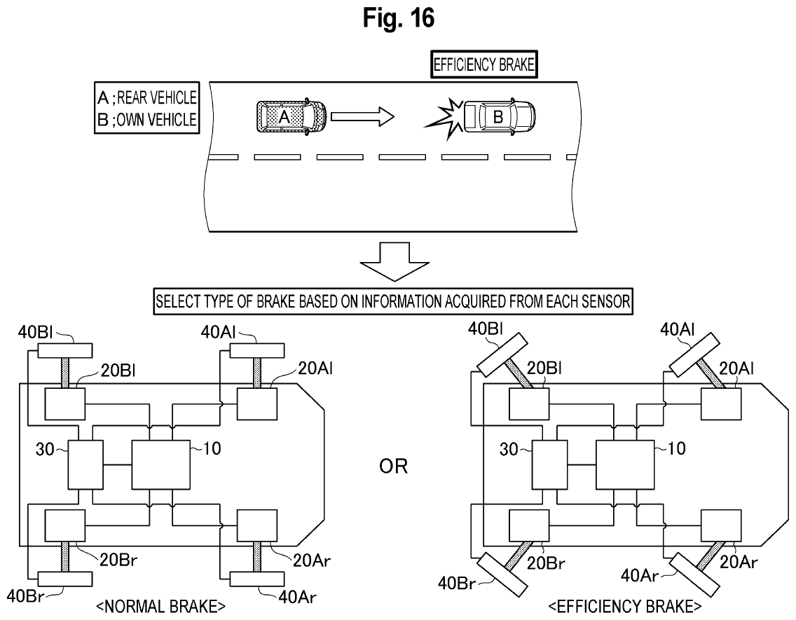

For example, as shown in FIG. 16, when the efficiency brake is operated under a situation where the rear vehicle approaches at a high speed, the own vehicle can stop at a short braking distance. However, there is a possibility that braking is too late and the rear vehicle collides.

In order to solve such a problem in advance, in the present embodiment, the control unit 10 selects the type of the brake to be operated, so as to avoid the rear-end collision from the rear vehicle.

Specifically, the control unit 10 selects whether to operate the normal brake or to operate the efficiency brake, based on the brake operation information acquired from the first sensor 50 and the rear vehicle information acquired from the second sensor 60.

For example, when determining that there is no possibility that the rear vehicle collides even if the efficiency brake is operated, because a sufficient inter-vehicle distance or the like is secured, the control unit 10 selects the efficiency brake.

On the other hand, when determining that there is a high possibility that the rear vehicle collides in a case where the efficiency brake is operated, because the sufficient inter-vehicle distance or the like is not secured, the control unit 10 selects the normal brake. In this way, in the present embodiment, by selecting the type of the brake to be operated, according to the situation surrounding the own vehicle, it is possible to reliably prevent the rear-end collision from the rear vehicle. Note that a selection criteria of the type of the brake can be arbitrarily set or changed in consideration of an occurrence probability of a collision accident or the like. For example, in a case where the occurrence probability of the collision accident is derived from the inter-vehicle distance and the relative speed, based on past cases of the collision accident and the derived occurrence probability of the collision accident is less than a threshold, the efficiency brake is selected. On the other hand, in a case where the occurrence probability exceeds the threshold, the normal brake may be selected.

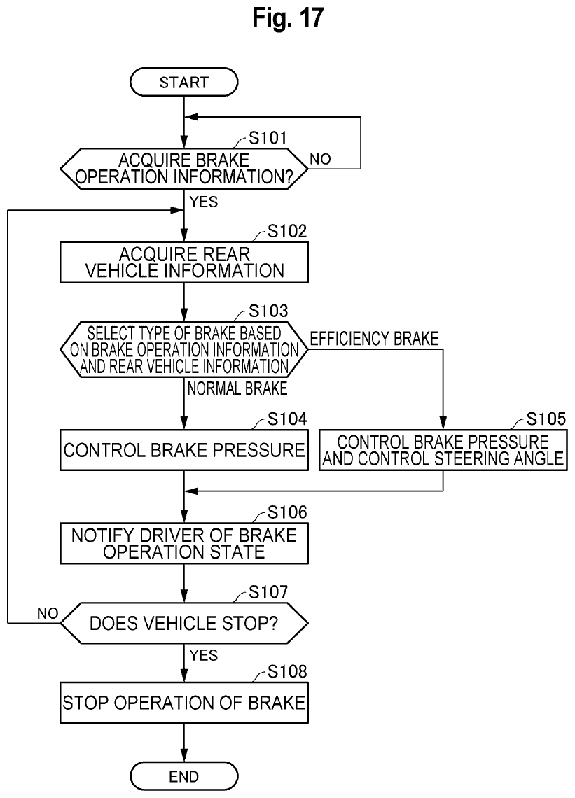

FIG. 17 is a flowchart showing an example of a processing procedure of the vehicle 1 on which the brake system is mounted.

The control unit 10 determines whether or not the brake operation information is acquired from the first sensor 50, during traveling of the vehicle 1 (step S101).

In a case where the brake operation information is not acquired (step S101: NO), the control unit 10 continues traveling, and in a case where the brake operation information is acquired (step S101: YES), the control unit 10 acquires the rear vehicle information from the second sensor 60 (step S102).

The control unit 10 selects the type of the brake to be operated, based on the brake operation information and the rear vehicle information acquired from the respective sensors (step S103).

In a case of selecting the normal brake, the control unit 10 instructs the brake means 30 to control the brake pressure (step S104).

In a case of selecting the efficiency brake, the control unit 10 instructs the brake means 30 to control the brake pressure and instructs the steering means 20 to control the steering angle of the wheel 40 in the aspect shown in FIG. 11 or 12 (step S105).

Then, the control unit 10 notifies the driver of the brake operation state (whether or not brake is operated, type of brake in operation, or the like), using the lamp of the notification means 70 or the like (step S106).

Before the vehicle 1 stops (step S107: NO), the control unit 10 continues to select the type of the brake and to operate the selected brake.

Thereafter, when detecting that the vehicle 1 stops (step S107: YES), the control unit 10 ends the notification of the brake operation state and stops the operation of the brake (step S108) and ends the processing.

As described above, according to the brake system according to the present embodiment, it is possible to perform the optimal brake control according to the situation surrounding the own vehicle.

### Modification

In the present embodiment, the type of the brake to be operated is selected on the premise of presence of the rear vehicle. However, the present embodiment is not limited to this. For example, the type of the brake to be operated may be selected, according to a road surface state where the own vehicle travels.

The second sensor 60 according to the modification detects road surface related information regarding the road surface state. The second sensor 60 includes, for example, a surface temperature sensor, a temperature and humidity sensor, an image camera, or the like. When detecting the road surface related information indicating the road surface state (for example, unevenness of road surface, dry, semi-wet, wetly, sherbet, snow, compacted snow, icy, humidity, temperature, road surface temperature, or the like), the second sensor 60 transmits the road surface related information to the control unit 10.

The control unit 10 selects whether to operate the normal brake or to operate the efficiency brake, based on the brake operation information acquired from the first sensor 50 and the road surface related information acquired from the second sensor 60.

For example, in a case where the road surface temperature is equal to or lower than zero degrees and the road surface is frozen, the control unit 10 selects the efficiency brake to shorten the braking distance as possible, and selects the normal brake in a case where the road surface is dry. As a result, it is possible to perform optimal and safe brake control according to the road surface state or the like.

Note that the second sensor 60 may detect a wear state (wear amount or the like) of a tire, in addition to the road surface state. In this case, the control unit 10 can select an optimum brake in consideration of the wear state of the tire, in addition to the road surface state. Of course, the present invention is not limited to this, and an optimal brake may be selected using various types of information related to the surrounding environment of the own vehicle detected by the second sensor 60.

Furthermore, regarding the control of the steering angle, the control unit 10 may set the steering angle so that the front wheels 40A form the shape of reverse “V” and the rear wheels 40B form the shape of “V”, using the steering means 20. Furthermore, the control unit 10 may set the steering angles so that the front wheels 40A form the shape of “V” and the rear wheels 40B form the shape of reverse “V”, using the steering means 20.

The control unit 10 may control the steering means 20 so that an angle between the traveling direction of the vehicle 1 and the steering angle of the right-side wheel 40Ar or 40Br, among the pair of wheels 40A and 40B and an angle between the traveling direction of the vehicle 1 and the steering angle of the left-side wheel 40Al or 40Bl are substantially identical to each other. That is, the steering means 20 may be controlled so that an angle formed by the traveling direction of the vehicle 1 and a rotation surface of the wheel 40Ar or 40Br and an angle formed by the traveling direction of the vehicle 1 and a rotation surface of the wheel 40Al or 40Bl are substantially identical to each other. As a result, the frictional forces acting on the left and right wheels are substantially identical to each other, and it can be expected that steering at the time of deceleration is stabilized.

Furthermore, the control unit 10 may set the steering angle of each wheel 40, according to the speed and/or the acceleration of the vehicle 1. For example, the control unit 10 acquires the speed and/or the acceleration based on the information detected by the second sensor 60. Then, the steering angle suitable for the speed and/or the acceleration of the vehicle 1 is derived, and the steering means 20 is controlled to achieve the derived steering angle. At this time, the steering angle may be derived, using pattern data of the speed and/or the acceleration and the steering angle of each wheel 40, stored in the memory 14. As a result, it is possible to efficiently perform deceleration according to the speed and/or the acceleration of the vehicle 1.

Furthermore, the control unit 10 may control the steering means 20 so that the steering angle of each of the pair of wheels 40A and 40B increases with respect to the traveling direction of the vehicle 1, as the speed of the vehicle 1 is lower.

### (5) Fifth Embodiment

Conventionally, in a two-wheel drive vehicle or a four-wheel drive vehicle, rotation of tires of drive wheels is decelerated to stop or decelerate the vehicle.

By the way, in a case where the vehicle changes a traveling direction (for example, turns curve or the like), it is necessary to appropriately perform deceleration according to a degree of the change in the traveling direction or the like. In particular, when the vehicle suddenly decelerates in a case where the traveling direction of the vehicle greatly changes by approaching a large curve or the like, slip or the like may occur, and this is dangerous.

Therefore, an object of the present invention is to provide an efficiency brake system that can appropriately perform deceleration in a case where a vehicle changes a traveling direction.

An efficiency brake system according to one aspect of the present invention includes at least a pair of wheels positioned substantially symmetrically on the left and right of a vehicle, steering means that can individually control a steering angle of each of the pair of wheels, a sensor that detects a change in a traveling direction of the vehicle, and a control unit controls the steering means so that the steering angle of each wheel becomes an angle set in accordance with the change in the traveling direction.

According to the present invention, it is possible to provide an efficiency brake system that can appropriately perform deceleration in a case where a vehicle changes a traveling direction.

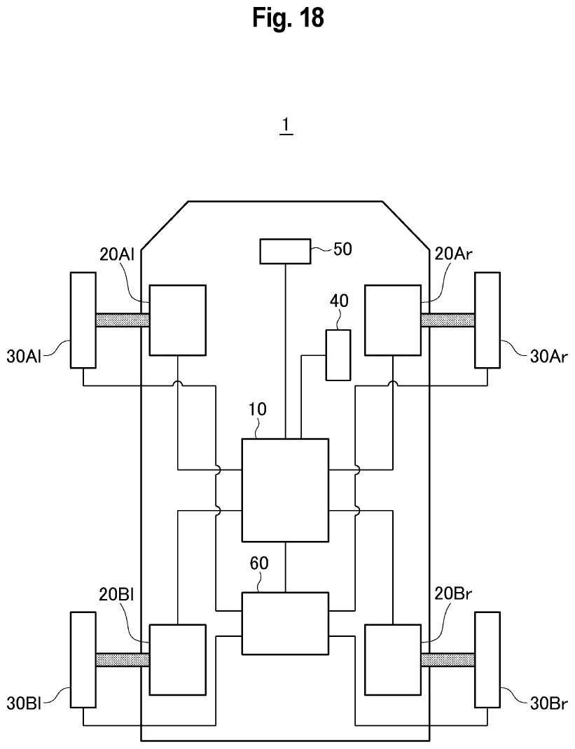

FIG. 18 is a diagram showing an example of a system configuration of the vehicle 1 on which the efficiency brake system according to the present embodiment is mounted. The vehicle 1 shown in FIG. 1 includes a control unit 10, steering means 20, wheels 30, a first sensor 40, a second sensor 50, and brake means 60. Furthermore, although not shown, various components constituting a conventional vehicle may be included. The vehicle 1 has an automatic driving function for assisting automatic driving of the vehicle 1, in addition to a manual driving function in which a driver drives the vehicle 1, and each driving mode can be arbitrarily selected.

The control unit 10 can cause the steering means 20 to control a steering angle of the wheel 30, using various types of information acquired from inside and outside of the vehicle 1. Here, the steering angle is an angle of the wheel 30 with respect to the traveling direction of the vehicle 1. For example, the control unit 10 instructs the steering angle of the wheel 30, to the steering means 20, based on information detected by the first sensor 40 and/or the second sensor 50. At this time, the control unit 10 can acquire information regarding deceleration of the vehicle 1 by a brake from the first sensor 40. Furthermore, the control unit 10 can acquire information regarding a speed, an acceleration, an angular speed, or an angular acceleration of the vehicle 1 from the second sensor 50. Furthermore, position information of the vehicle 1 can be acquired from the second sensor 50.

The steering means 20 can individually control the steering angle of each wheel 30, based on the instruction received from the control unit 10. In the present embodiment, as the steering means 20, steering means 20Ar, 20Al, 20Br, and 20Bl respectively corresponding to four wheels 30Ar, 30Al, 30Br, and 30Bl included in the vehicle 1 are included, and each of the steering means 20Ar, 20Al, 20Br, and 20Bl may be configured to individually set and control a steering angle of each of the wheels 30Ar, 30Al, 30Br, and 30Bl.

The vehicle 1 includes at least a pair of wheels 30, and the wheels 30 are substantially symmetrically arranged on the left and right of the vehicle 1. In the present embodiment, the vehicle 1 includes four wheels, that is, a pair of right and left front wheels 30A (30Ar and 30Al) and a pair of right and left rear wheels 30B (30Br and 30Bl).

A HUB motor (hub motor) that is an electric motor mounted in a hub may be mounted on each wheel 30. Note that, even if the motor itself is not mounted in the hub, a motor (in wheel motor (IWM) ) in which a driving force of the electric motor is directly transmitted to the wheel may be mounted. The HUB motor is mounted on all the four wheels, a movement of each of the wheels 30 can be individually controlled. Therefore, this is preferable to realize an efficiency brake that changes angles of the wheels and performs deceleration.

The first sensor 40 detects information regarding the brake by the brake means 60. For example, the first sensor 40 detects braking of the wheel 30 is activated by the brake means 60, by a brake operation by a driver or automatic driving control, and transmits the detected information to the control unit 10.

The second sensor 50 may be various sensors mounted on the vehicle 1. For example, the second sensor 50 may be a wheel speed sensor that measures the number of rotations of the wheel 30, a steering angle sensor that measures an angle of a steering wheel, a yaw rate sensor that detects a speed at which the vehicle 1 rotates, a GPS sensor, or the like, in addition to a speed sensor, an acceleration sensor, a gyro sensor, or the like. The second sensor 50 transmits detected information to the control unit 10.

The brake means 60 can brake each wheel 30, based on the instruction received from the control unit 10. The brake means 60 may include, for example, a wheel cylinder (not shown) provided on each of the wheels 30Ar, 30Al, 30Br, and 30Bl, a brake actuator (not shown) connected to the wheel cylinder, and the like. The brake actuator brakes each of the wheels 30Ar, 30Al, 30Br, and 30Bl by controlling a brake pressure generated by a hydraulic pump or the like driven by a motor to an arbitrary magnitude and supplying the brake pressure to the wheel cylinder. In a case of detecting that the driver steps on a brake pedal, the control unit 10 may issue an instruction to the brake means 60 to brake the wheel 30, or may issue an instruction to the brake means 60 to brake the wheel 30 by automatic driving control.

Since a configuration of the control unit 10 according to the present embodiment is similar to that in FIG. 2, illustration is omitted.

The control unit 10 includes, for example, a processor 12 and a memory 14.

The processor 12 controls an operation of the entire vehicle 1. As the processor 12, for example, a central processing unit (CPU), a micro processing unit (MPU), a field programmable gate array (FPGA), a microcomputer (microcontroller), or the like can be used. The processor 12 functions as a control unit that controls the operation of the entire vehicle 1, by executing a program stored in the memory 14.

The memory 14 stores various programs to be executed by the processor 12 and various types of data. The memory 14 may include, for example, a volatile storage device such as a read only memory (ROM) or a random access memory (RAM) and a nonvolatile storage device such as a hard disk drive (HDD) or a flash memory. Various types of data includes, for example, pattern data of a steering angle of each of the four wheels 30Ar, 30Al, 30Br, and 30Bl when the efficiency brake is used and condition data for operating the efficiency brake (for example, threshold of vehicle speed or the like).

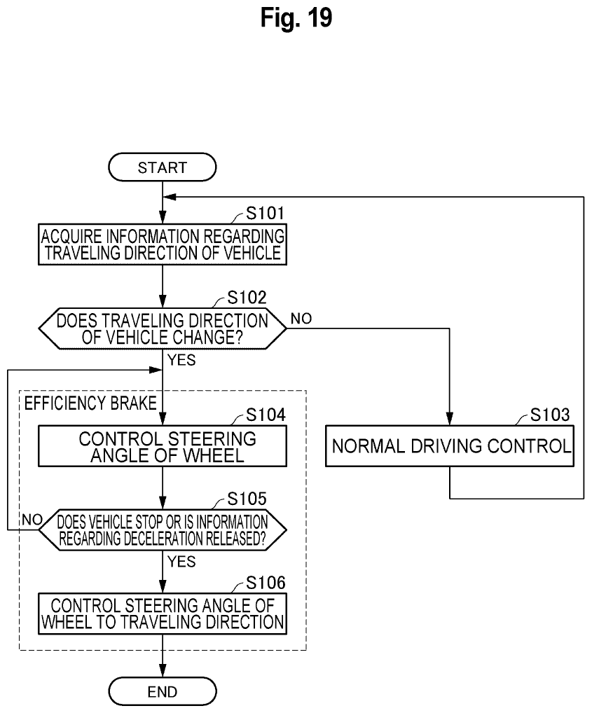

FIG. 19 is a flowchart showing an example of a processing procedure of the vehicle 1 on which the efficiency brake system is mounted.

While the vehicle 1 is traveling, the control unit 10 acquires information regarding the traveling direction of the vehicle 1 (step S101). Moreover, the control unit 10 determines whether or not the traveling direction of the vehicle 1 has changed, based on the acquired information (step S102). For example, the control unit 10 can determine whether or not the traveling direction has changed, based on a change in the angular speed detected by the gyro sensor. Furthermore, the control unit 10 may acquire the position information of the vehicle 1 from the GPS sensor and acquire information regarding the change in the traveling direction from information regarding a road where the vehicle 1 is traveling. Note that, in the present embodiment, an aspect is indicated in which the efficiency brake is operated in a case where the change in the traveling direction of the vehicle 1 is detected. However, the present embodiment is not limited to this. For example, in a case where the change in the traveling direction of the vehicle 1 is detected and the speed of the vehicle exceeds a set reference speed (for example, ox km/h), the efficiency brake may be operated.

In a case where the change in the traveling direction of the vehicle 1 is not detected (step S102: NO), the control unit 10 proceeds to step S103, performs normal driving control, and returns to step S101. On the other hand, when the change in the traveling direction of the vehicle 1 is detected (step S102: YES), the control unit 10 outputs an instruction to the steering means 20 and controls the steering angle of the wheel 30 (step S104), and operates the efficiency brake.

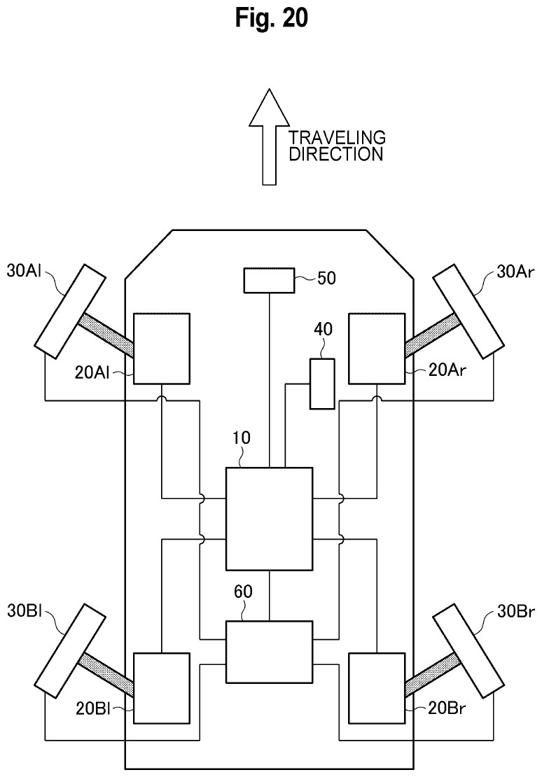

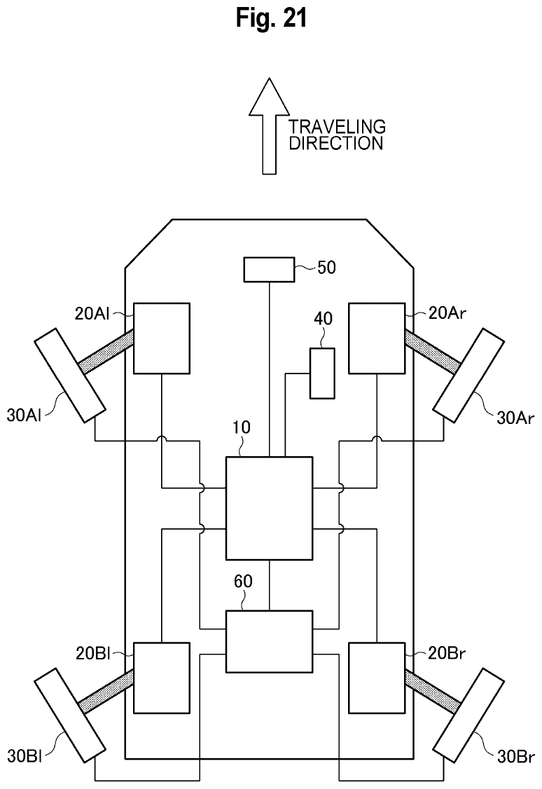

FIGS. 20 and 21 are diagrams for explaining control of the steering angle of the wheel 30 by the steering means 20. In the examples shown in FIGS. 20 and 21, the vehicle 1 can individually control the steering angles of all the four wheels 30Ar, 30Al, 30Br, and 30Bl by the corresponding steering means 20Ar, 20Al, 20Br, and 20Bl. The deceleration by the brake means 20 is performed by braking rotation of the wheel 30. However, the steering means 20 cancels a moment toward the traveling direction to perform the deceleration, by changing the steering angle of each of the four wheels.

In the example shown in FIG. 20, the control unit 10 controls the steering angles so that each of the front wheels 30Ar and 30Al and the rear wheels 30Br and 30Bl form the shape of reverse “V”, as viewed from an upper surface of the vehicle 1, using the steering means 20. That is, the control unit 10 controls the steering angle so that the right-side wheel 30Ar faces leftward and the left-side wheel 30Al faces rightward, using the steering means 20. Furthermore, the control unit 10 controls the steering angle so that the right-side wheel 30Br faces leftward and the left-side wheel 30Bl faces rightward, using the steering means 20. In this way, by narrowing a traveling direction side of the pairs of left and right wheels 30A and 30B toward the inner side, using the steering means 20, a frictional force on a contact surface between the wheel 30 and the ground is increased, and the deceleration is realized. Conversely, the control unit 10 may control the steering angles, so that each of the front wheels 30Ar and 30Al and the rear wheels 30Br and 30Bl form the shape of “V”, as viewed from the upper surface of the vehicle 1, using the steering means 20 (refer to FIG. 21).

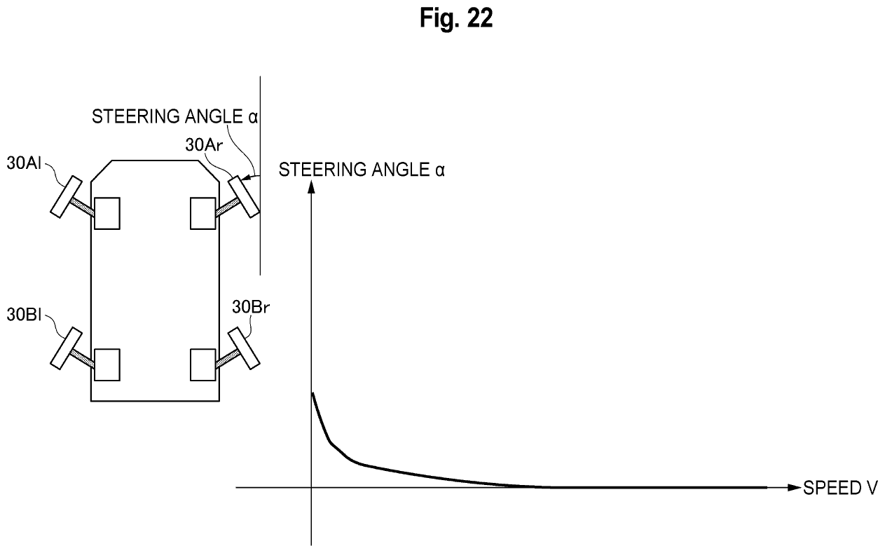

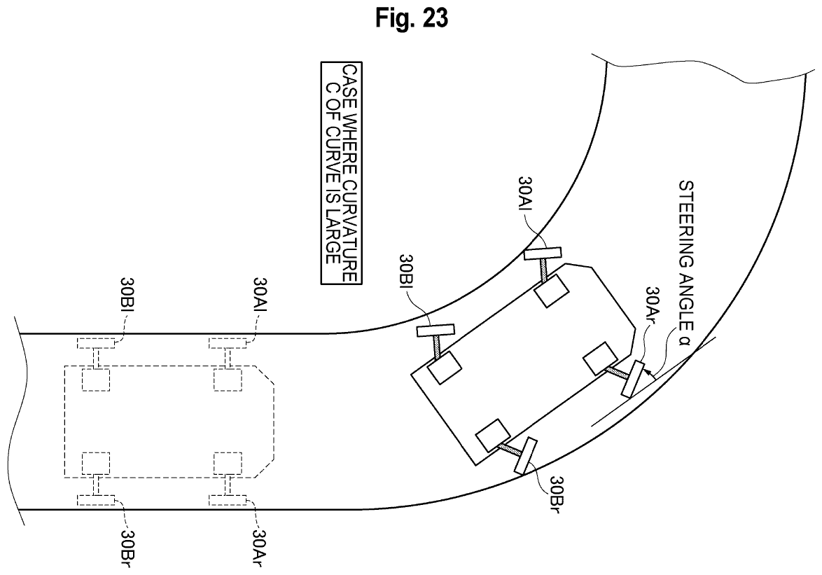

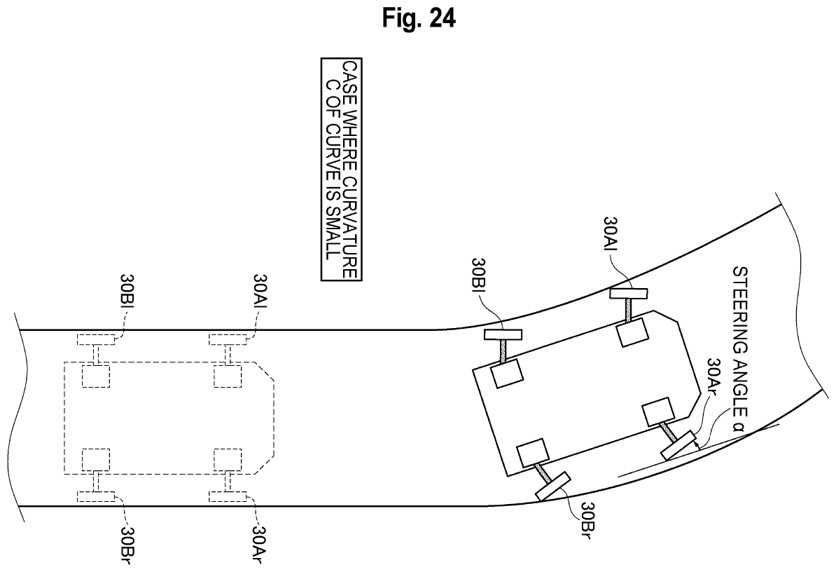

Furthermore, the control unit 10 controls the steering means 20 so that the steering angle of the wheel 30 becomes an angle according to the change in the traveling direction of the vehicle 1. As shown in FIG. 22, as a steering angle a of the wheel 30 with respect the traveling direction is larger (that is, as traveling direction side is narrowed in a case of shape of reverse “V” and as traveling direction side is widened in a case of shape of “V”), the frictional force with respect to the ground increases, and an effect of the deceleration increases. Therefore, for example, in a case where the traveling direction changes because the vehicle 1 approaches a curve, the steering angle a of the wheel may be controlled according to a size of the curve, and a degree of the deceleration of the vehicle 1 may be changed. For example, as shown in FIG. 23, in a case where a curvature (curving degree) C of the curve is larger, the steering angle a of the wheel 30 is set to be larger to increase the degree of the deceleration. On the other hand, as shown in FIG. 24, in a case where the curvature C of the curve is smaller, the steering angle a of the wheel 30 may be set to be smaller to loosen the degree of the deceleration.

However, in a case where the present invention does not intend to be limited to such setting and, for example, it is desired to achieve both of shortening a time period before the deceleration and securing stability of traveling, the control unit 10 performs control so that the steering angle a of the wheel 30 with respect to the traveling direction increases as the speed of the vehicle 1 is lower. Of course, in a case where it is desired to drop a traveling speed of the vehicle 1 at a shorter distance, control may be performed so that the steering angle & of the wheel 30 with respect to the traveling direction increases as the speed of the vehicle 1 is higher. A relationship between the speed of the vehicle 1 and the steering angle & of the wheel 30 is not limited to these and can be set so that efficient and stable braking of the vehicle 1 can be performed. At this time, the control unit 10 may derive an appropriate steering angle using pattern data indicating a relationship between a change amount of the traveling direction of the vehicle 1, the speed of the vehicle 1, and the steering angle of the wheel 30, stored in the memory 14.

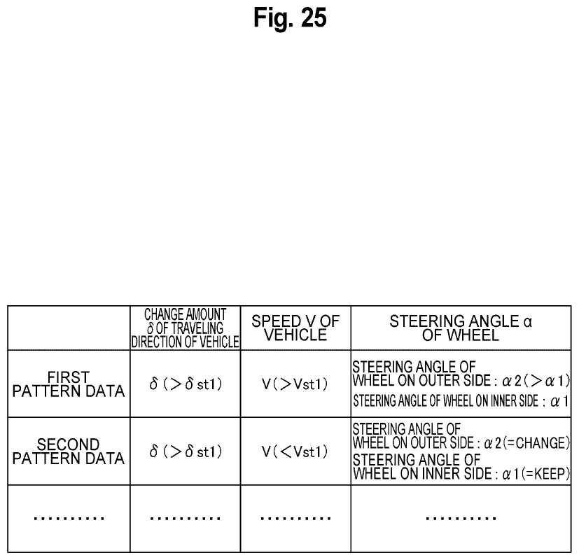

FIG. 25 is a diagram showing an example of the pattern data of the steering angle of the wheel 30 appropriate for efficiently stopping the vehicle 1.

In a case where a change amount o of the traveling direction of the vehicle exceeds a first reference change amount δst1 and a speed V of the vehicle 1 exceeds a first reference speed Vst1, the control unit 10 sets a steering angle α2 of the wheels 30Ar and 30Br positioned on the outer side (that is, right side) to be larger than a steering angle al of the wheels 30Al and 30Bl positioned on the inner side (that is, left side), using first pattern data D1.

On the other hand, in a case where the speed V of the vehicle 1 does not exceed the first reference speed Vstl although the change amount δ of the traveling direction of the vehicle exceeds the first reference change amount δst1, the control unit 10 sets the steering angle α2 of the wheels 30Al and 30Bl positioned on the outer side to be changed (“CHANGE”) , without changing (“KEEP”) the steering angle α1 of the wheels 30Ar and 30Br positioned on the inner side, using second pattern data D2.

The pattern data described above is merely an example, and the steering angle of the vehicle 30 may be controlled in other aspects. For example, the control unit 10 may control the steering means 20 so that the steering angle of the outer wheels 30Ar and 30Br and the steering angle of the inner wheels 30Al and 30Bl are substantially identical to each other. That is, the steering means 20 may be controlled so that an angle formed by the traveling direction of the vehicle 1 and a rotation surface of the wheel 30Ar or 30Br and an angle formed by the traveling direction of the vehicle 1 and a rotation surface of the wheel 30Al or 30Bl are substantially identical to each other. As a result, the frictional forces acting on the left and right wheels are substantially identical to each other, and it can be expected that steering at the time of deceleration is stabilized.

When the steering angle of the wheel 30 is controlled in this way, the control unit 10 determines whether or not the vehicle 1 stops or the information regarding the deceleration is released (step S105). In a case where the vehicle 1 does not stop or the information regarding the deceleration is not released (step S105: NO), the control unit 10 returns to step S104 and controls the steering angle of the wheel 30. On the other hand, when the vehicle 1 stops or the information regarding the deceleration is released (step S105: YES), the control unit 10 stops the operation of the efficiency brake by controlling the steering means 20 so that the steering angle of the wheel 30 becomes the same as the traveling direction (step S106) and ends the processing.

Note that, the control unit 10 may naturally set the steering angle of each wheel 30, according to the speed and/or the acceleration of the vehicle 1. For example, the control unit 10 acquires the speed and/or the acceleration based on the information detected by the second sensor 50. Then, the steering angle suitable for the speed and/or the acceleration of the vehicle 1 is derived, and the steering means 20 is controlled to achieve the derived steering angle. At this time, the steering angle may be derived, using the pattern data of the speed and/or the acceleration and the steering angle of each wheel 30, stored in the memory 14. As a result, it is possible to efficiently perform deceleration according to the speed and/or the acceleration of the vehicle 1.

As described above, according to the present embodiment, when detecting the change in the traveling direction because the vehicle 1 approaches the curve or the like, the control unit 10 outputs the instruction to the steering means 20 and changes the steering angle of the wheel 30 to an angle according to the change in the traveling direction of the vehicle 1 and performs control to cancel the moment toward the traveling direction to decelerate. As a result, it is possible to avoid slip or the like caused by sudden deceleration, while efficiently performing deceleration according to the change in the traveling direction of the vehicle 1.

Note that, while the vehicle 1 is traveling the curve, control may be performed so as to change only the steering angle of the wheel 30 positioned on the outer side with respect to the curve according to the curve. As a result, it is possible to control the steering angle of the wheel 30 having a larger influence during curve traveling and efficiently decelerate.

Note that the present invention is not limited to each of the embodiments and modifications described above, and various modifications can be made without departing from the gist of the present invention. Therefore, the embodiments are merely examples in all respects, and are not to be interpreted in a limited manner. For example, an order of each processing step described above can be arbitrarily changed within the range with no contradiction of processing contents, or each processing step can be executed in parallel.

### Reference Signs List

1 Vehicle
10 Control unit
12 Processor
14 Memory
20 Steering means
30 Wheel
40 First sensor
50 Second sensor

1.-6 (canceled)

7. An efficiency brake system comprising:
at least a pair of wheels positioned substantially symmetrically on the left and right of a vehicle;
steering means configured to individually control a steering angle of each of the pair of wheels;
a sensor configured to detect an acceleration of the vehicle; and
a control unit configured to control the steering means in a case where the acceleration of the vehicle satisfies a first condition and change the steering angle of each wheel with respect to a traveling direction of the vehicle.

8. The efficiency brake system according to claim 7, wherein the first condition is that a signal indicating that at least one of sudden acceleration, sudden braking, and sudden steering of the vehicle has occurred is detected.

9. The efficiency brake system according to claim 7, wherein the control unit controls the steering means so that the steering angle of each wheel with respect to the traveling direction of the vehicle becomes an angle according to the acceleration.

10. The efficiency brake system according to claim 7, wherein the control unit controls the steering means so that a right-side wheel faces leftward and a left-side wheel faces rightwards or the right-side wheel faces rightwards and the left-side wheel faces leftward, of the pair of wheels, with respect to the traveling direction of the vehicle.

11. An efficiency brake system comprising:
at least a pair of wheels positioned substantially symmetrically on the left and right of a vehicle;
steering means configured to individually control a steering angle of each of the pair of wheels;
brake means configured to generate a braking force in the pair of wheels; and
a control unit configured to control the steering means and the brake means, wherein
the control unit controls the brake means so that the braking force on the pair of wheels is reduced in a case of determining that any one wheel during braking tends to be locked and to control the steering means so that the pair of wheels form a shape of substantially reverse V as viewed from an upper surface of the vehicle.

12. The efficiency brake system according to claim 11, wherein the control unit controls the brake means so that the braking force on the pair of wheels is reduced in a case of determining that any one wheel during braking tends to be locked and controls the steering means so that the pair of wheels form a shape of substantially V as viewed from the upper surface of the vehicle.

13. The efficiency brake system according to claim 11, wherein the control unit controls the brake means so that the braking force on the pair of wheels is reduced in a case of determining that any one wheel during braking tends to be locked and controls the steering means by alternately switching a first steering mode in which the steering means is controlled so that the pair of wheels form the shape of substantially reverse V as viewed from the upper surface of the vehicle and a second steering mode in which the steering means is controlled so that the pair of wheels form the shape of substantially V as viewed from the upper surface of the vehicle.

14. The efficiency brake system according to claim 11, further comprising:
a wheel speed sensor configured to detect a wheel speed of each of the pair of wheels, wherein the control unit determines whether or not any one wheel during braking tends to be locked, based on the detected wheel speed.

15. The efficiency brake system according to claim 11, wherein
the control unit controls the steering means so that the steering angle of each of the pair of wheels with respect to the traveling direction of the vehicle increases, as a speed of the vehicle is lower.

16. The efficiency brake system according to claim 11, further comprising:
notification means configured to issue a predetermined alarm to a driver, when the control unit controls the steering means and the brake means.

17. A brake system comprising:
at least a pair of wheels positioned substantially symmetrically on the left and right of a vehicle;
steering means configured to individually control a steering angle of each of the pair of wheels;
brake means configured to generate a braking force in the pair of wheels;
a first acquisition unit configured to acquire brake operation information regarding a brake operation of the vehicle;
a second acquisition unit configured to acquire surrounding environment information regarding a surrounding environment of the vehicle; and
a control unit configured to control the steering means and the brake means, wherein
the control unit selects one of a normal brake for braking the vehicle by controlling the brake means based on the brake operation information and the surrounding environment information and an efficiency brake for braking the vehicle by controlling the brake means and the steering means.

18. The brake system according to claim 17, wherein
the surrounding environment information includes rear vehicle information indicating an inter-vehicle distance with a rear vehicle and a relative speed, and
the control unit selects one of the normal brake and the efficiency brake, based on the brake operation information and the rear vehicle information.

19. The brake system according to claim 17, wherein
the surrounding environment information includes road surface related information regarding a road surface state, and
the control unit selects one of the normal brake and the efficiency brake, based on the brake operation information and the road surface related information.

20. The brake system according to claim 17, wherein
the control unit controls the brake means so that a braking force on the pair of wheels is reduced in a case where the efficiency brake is selected and controls the steering means so that the pair of wheels form a shape of substantially reverse V as viewed from an upper surface of the vehicle.

21. The brake system according to claim 17, further comprising: notification means configured to notify outside of a brake operation state.

22.-26 (canceled)
